(19) United States
(12) Patent Application Publication
(10) Pub. No.: US 2014/0102285 A1
(43) Pub. Date: Apr. 17, 2014

(54) Recording System for Ensemble Performance and Musical Instrument Equipped With The Same

(71) Applicant: YAMAHA CORPORATION, Hamamatsu-shi (JP)

(72) Inventors: Shinya Koseki, Shizuoka-ken (JP); Takayoshi Aihara, Shizuoka-ken (JP)

(73) Assignee: YAMAHA CORPORATION, Hamamatsu-shi (JP)

(21) Appl. No.: 14/108,702

(22) Filed: Dec. 17, 2013

Related U.S. Application Data
(62) Division of application No. 12/349,639, filed on Jan. 7, 2009.

(30) Foreign Application Priority Data
Jan. 11, 2008 (JP) 2008-004381

(51) Int. Cl. G10H 1/00

(52) U.S. Cl. CPC G10H 1/0058
USPC 84/609

(57) ABSTRACT

An automatic player piano is equipped with a recording system equipped with a sequencer, to which event data codes for note-on and note-off events and a digital external audio signal expressing singer's voice are supplied; the sequencer supplements duration data codes to the event data codes, and produces RIFF audio data codes expressing the voice; and respectively stores the event data codes and duration data codes and the RIFF audio data codes in a standard MIDI file and a RIFF file.

### CROSS-REFERENCE TO RELATED APPLICATIONS

This application is a divisional of U.S. patent application Ser. No. 12/349,639 filed on Jan. 7, 2009. This application claims the benefit and priority of JP 2008-004381 filed Jan. 11, 2008. The entire disclosures of each of the above applications are incorporated herein by reference.

### FIELD OF THE INVENTION

This invention relates to a recording system for musical instruments and, more particularly, to a recording system used for plural musical instruments performed in ensemble and a musical instrument equipped with the recording system.

### DESCRIPTION OF THE RELATED ART

Musicians and music students are used to recording performances on their musical instruments, and review their performances through the playback. Conventionally, a recorder such as, for example, a tape recorder or a disk recorder is used for the recording. While a musician is performing a music tune on a musical instrument such as an electronic keyboard, the electronic tones are radiated from the loud speakers of the electronic keyboard, and reach the recorder. The sound waves of electronic tones are converted to an electric signal expressing the electronic tones through the recorder, and the electric signal or pieces of music data are stored in an information storage medium of the recorder.

However, a problem is encountered in the prior art recorder in that environmental noise is converted to the electric signal concurrently with the electronic tones. The environmental noise and electronic tones are concurrently reproduced in the playback, and the musicians and music students suffer from the low quality reproduced tones.

A countermeasure is proposed in Japan Patent Application laid-open No. 2006-39261. While a musician is performing a music tune on the electronic keyboard, an audio signal is internally produced through the electronic tone generator on the basis of the music data codes expressing the performance, and is supplied from the electronic tone generator to not only the sound system but also the recording system disclosed in the Japan Patent Application laid-open. The waveform of electric signal is processed in the prior art recording system so as to produce pieces of music data, and the pieces of music data are stored in the information storage medium of the prior art recording system. The audio signal does not contain any environmental noise so that the reproduced tones are higher in quality than the tones reproduced through the recorder are.

The prior art recording system is conducive to the enhancement of tone quality in the solo performance on the electronic keyboard. However, the prior art recording system is not available for a performance in ensemble with another musical instrument. While the musician is performing a music tune on the electronic keyboard in ensemble with an acoustic musical instrument, only the pieces of music data expressing the electronic tones are stored in the information storage of prior art recording system. The prior art recording system is not able to process to the acoustic tones. If the musicians wish to record the ensemble performance, another recorder is to be prepared for the acoustic musical instrument. There is not any guarantee that another recorder stores the audio signal in a music data file defined in the protocols employed in the prior art recording system. Thus, the two recorders are required for the ensemble performance.

### SUMMARY OF THE INVENTION

It is therefore an important object of the present invention to provide a recording system, through which users can record an ensemble performance on plural musical instruments in plural data files defined in different protocols.

It is also an important object of the present invention to provide a musical instrument equipped with the recording system.

In accordance with one aspect of the present invention, there is provided a recording system for recording an ensemble performance in at least one music data file comprising a first data receiving port for receiving pieces of first audio data defined in first data recording protocols, a second data receiving port for receiving pieces of second audio data defined in second data recording protocols different from the first data recording protocols, and an information processing system connected to the first data receiving port and the second data receiving port. A computer program runs on the information processing system so as to realize a first data producer producing first audio data codes to be stored in the aforesaid at least one music data file and expressing a first sort of music sound and timing at which pieces of the first sort of music sound are to be reproduced on the basis of the pieces of the first audio data, a second data producer producing second audio data codes to be stored in the aforesaid at least one music data file and expressing a second sort of music sound on the basis of the pieces of the second audio data, and a file producer separately storing the first audio data codes and the second audio data codes in the aforesaid at least one music data file.

In accordance with another aspect of the present invention, there is provided a musical instrument comprising plural manipulators selectively depressed and released so as to specify pieces of first sort of music sound to be produced, a music data producer connected to the plural manipulators and producing pieces of first audio data defined in first data recording protocols for expressing the pieces of first sort of music sound, an interface connectable to an external music data source and receiving pieces of second audio data defined in second data recording protocols different from the first data recording protocols for expressing pieces of second sort of music sound, and a recording system connected to the music data producer and the interface, recording an ensemble performance in at least one music data file and including a first data receiving port for receiving the pieces of first audio data, a second data receiving port for receiving the pieces of second audio data and an information processing system connected to the first data receiving port and the second data receiving port. A computer program runs on the information processing system so as to realize a first data producer producing first audio data codes to be stored in the aforesaid at least one music data file and expressing the first sort of music sound and timing at which the pieces of the first sort of music sound are to be reproduced on the basis of the pieces of the first audio data, a second data producer producing second audio data codes to be stored in the aforesaid at least one music data file and expressing the second sort of music sound on the basis of the pieces of the second audio data and a file producer separately storing the first audio data codes and the second audio data codes in the aforesaid at least one music data file.

### BRIEF DESCRIPTION OF THE DRAWINGS

The features and advantages of the recording system and musical instrument will be more clearly understood from the following description taken in conjunction with the accompanying drawings, in which

FIG. 1 is a perspective view showing the external appearance of an automatic player piano of the present invention,

FIG. 2 is a view showing the structure of a grand piano and the configuration of an electric system of the automatic player piano,

FIG. 3 is a circuit diagram showing the circuit configuration of a digital mixer incorporated in the automatic player piano,

FIG. 4A is a front view showing visual images on a touch screen when a user selects a recording from a job menu,

FIGS. 4B and 4C are front views showing visual images on a touch screen when the user gives different answers to an information processing system in an audio recording mode,

FIGS. 5A to 5C are front views showing visual images on the touch screen when the user gives different answers to the information processing system in a MIDI plug audio recording mode,

FIGS. 6A to 6E are flowcharts showing a sequence of jobs of a subroutine program for a recording,

FIGS. 7A to 7D are flowchart showing a sequence of jobs of a subroutine program for an ensemble playback,

FIG. 8 is a perspective view showing another automatic player piano of the present invention, and

FIG. 9 is a view showing the structure of a grand piano and the configuration of an electric system of the automatic player piano.

### DESCRIPTION OF THE PREFERRED EMBODIMENTS

A musical instrument embodying the present invention largely comprises plural manipulators, a music data producer, an interface and a recording system. The plural manipulators are connected to the music data producer, and the music data producer and interface are connected to the recording system. An external music data source is connectable to the interface.

A user selectively depresses and releases the plural manipulator so as to specify pieces of first sort of music sound to be produced, and the music data producer produces pieces of first audio data defined in first data recording protocols. The pieces of first audio data express the pieces of first sort of music sound, and are transferred to the recording system.

The external music data source produces pieces of second audio data defined in second data recording protocols different from the first data recording protocols. The pieces of second audio data express pieces of second sort of music sound, and are transferred through the interface to the recording system.

The recording system is capable of recording an ensemble performance in at least one music data file, and includes a first data receiving port, a second data receiving port and an information processing system. The first data receiving port and second data receiving port are connected to the information processing system.

The pieces of first audio data arrive at the first data receiving port, and the pieces of second audio data arrive at the second data receiving port. A computer program runs on the information processing system, and realizes a first data producer, a second data producer and a file producer.

The first data producer produces first audio data codes to be stored in the aforesaid at least one music data file on the basis of the pieces of the first audio data. The first audio data codes express the first sort of music sound and timing at which the pieces of the first sort of music sound are to be reproduced. The second data producer produces second audio data codes to be stored in the aforesaid at least one music data file on the basis of the pieces of the second audio data. The second audio data codes express the second sort of music sound. The file producer produces the at least one music data file, and separately stores the first audio data codes and the second audio data codes in the at least one music data file.

As will be appreciated from the foregoing description, the recording system has the single information processing system, and the first data producer and second data producer are realized through execution of the computer program. Although the pieces of first audio data and pieces of second audio data are defined in the different data recording protocols, the first data producer and second data separately producer produce the first audio data codes and second audio data codes on the basis of the pieces of first audio data and pieces of second audio data. The system configuration of recording system is rather simple. The first audio data codes and second audio data codes are concurrently produced, and are separately stored in the at least one music data file.

If the pieces of first sort of music sound and the pieces of second sort of music sound are recorded by means of a single recorder, pieces of mixed music sound are stored in a single music data file. When a user wishes to reproduce the pieces of first sort of music sound and pieces of second sort of music sound, the pieces of music data are read out from the single music data file, and are converted to the pieces of mixed music sound. However, the pieces of mixed music sound are poorer in tone quality than the pieces of first sort of music sound and pieces of second sort of music sound. The musical instrument of the present invention produces the high quality music sound by virtue of the separately recorded pieces of music sound.

In the following description, term “front” is indicative of a position closer to a player, who is sitting on a stool, than a “rear” position. A line drawn between a front position and a corresponding rear position extends in a “fore-and-aft direction”, and a “lateral direction” crosses the fore-and-aft direction at right angle. An “up-and-down” direction is normal to a plane defined by the fore-and-aft direction and lateral direction.

### First Embodiment

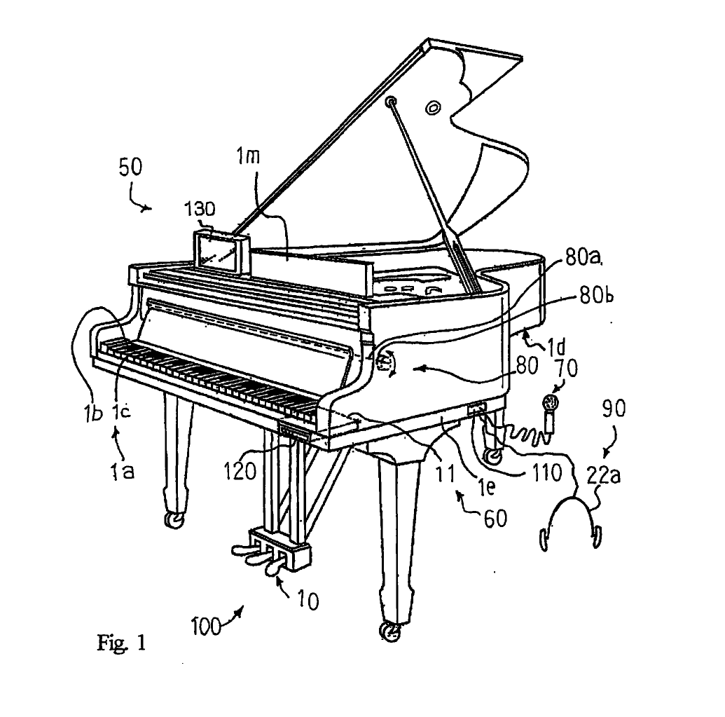

Referring first to FIG. 1 of the drawings, an automatic player piano embodying the present invention is designated in its entity by reference numeral 100, and largely comprises a grand piano 50 and an electric system. The electric system serves as an automatic playing system 60, a recording system 70, a muting system 80 and a playback system 90, and the automatic playing system 60, recording system 70, muting system 80 and playback system 90 are built in the grand piano 50.

The grand piano 50 is able to produce acoustic piano tones. While a human player is playing a music tune on the grand piano 50, the acoustic piano tones are produced in the grand piano 50 along the music tune, and are radiated from the grand piano 50. The grand piano 50 is available for an ensemble with another musical instrument and/or a singer.

The automatic playing system 60 is provided for a playback through an automatic playing. In other words, the playback of music tune is realized through the grand piano 50 on the basis of a set of music data codes expressing performance of the music tune.

The muting system 80 prohibits the grand piano 50 from generation of the acoustic piano tones, and produces electronic tones instead of the acoustic piano tones. While a musician is performing a music tune on the grand piano 50, the muting system 80 monitors the grand piano 50 for the fingering, produces music data codes expressing the electronic tones to be produced on the basis of the fingering of musician, and further produces an internal audio signal. The internal audio signal is converted to the electronic tones. Since the musician easily controls the loudness of electronic tones, he or she can enjoy the performance without any disturbance to neighborhood.

The recording system 70 processes the internal audio signal and an external audio signal, and produces predetermined music files in different file formats. One of the file formats is defined in MIDI (Musical Instrument Digital Interface) protocols, and pieces of music data are stored in an SMF (Standard MIDI file). Another of the file formats is an RIFF (Resource Interchange File Format), and pieces of music data are stored in the RIFF file. The SMF and RIFF file are well known to persons skilled in the art, and no further description is hereinafter incorporated.

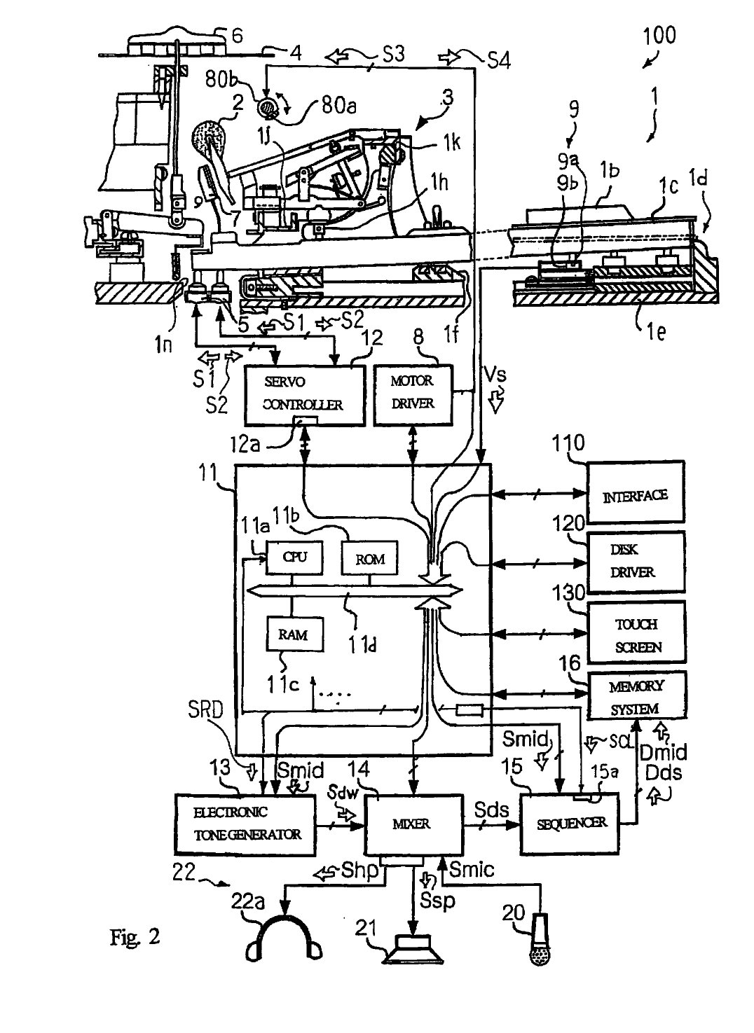

The recording system 70 is responsive to user's instruction so as to produce the RIFF file or both of the SMF and RIFF file on the basis of one of or both of the internal audio signal and external audio signal. Thus, an ensemble performance on the grand piano 50 and an external sound source such as another musical instrument or a singer is recordable through the single recording system 70. The above-described components of automatic player piano 100 are hereinafter described in more detail with reference to FIG. 2 concurrently with FIG. 1.

The playback system reproduces a solo performance or an ensemble performance. When the user wants to reproduce a solo performance through the acoustic piano tones, the automatic playing system 60 is activated for the solo performance. On the other hand, when the user wants to reproduce a solo performance through the electronic tones, the playback system 90 is activated. The ensemble performance is reproduced through the electronic tones or both of the acoustic piano tones and electronic tones.

### Grand Piano

The grand piano 50 includes a keyboard 1a, a piano cabinet 1d, hammers 2, action units 3, strings 4, dampers 6 and a pedal system 10. An inner space is defined in the piano cabinet 1d, and a key bed 1e gives the bottom to the inner space. The keyboard 1a is mounted on the key bed 1e, and is exposed to a pianist. The hammers 2, action units 3 strings 4 and dampers 6 are provided in the inner space, and pedals of the pedal system 10 are exposed to a pianist under the piano cabinet 1d. A music rack 1m stands on the piano cabinet 1d.

Black keys 1b, white keys 1c, a balance rail 1f and capstan screws 1h are incorporated in the keyboard 1a, and the black keys 1b and white keys 1c independently pitch up and down with respect to the balance rail 1f. The capstan screws 1h are partially implanted into the rear portions of black keys 1b and the rear portions of white keys 1c, and project over the upper surfaces of black keys 1b and the upper surfaces of white keys 1c. For this reason, when a pianist depresses the front portions of black keys 1b and the front portions of white keys 1c, the front portions are sunk, and the capstan screws 1h are raised. The black keys 1b and white keys 1c stay at rest position without any force exerted on the front portions, and reach end positions at end of the travel.

“Depressed key” means any one of the black keys 1b and white keys 1c which is found on the way to the end position, and “released key” means the black key 1b or white key 1c which is found on the way to the rest position.

The action units 3 are provided for the keys 1b and 1c, respectively, and the capstan screws 1h are held in contact with the associated action units 3. The hammers 2 are associated with the action units 3, respectively, and strings 4 are respectively stretched over the hammers 2. The action unit 3 has a back check 7, and the back check 7 projects from the rear portion of associated key 1b or 1c. The hammers 2 are softly landed on the back checks 7 after the rebound on the strings 4.

The dampers 6 are provided in association with the strings 4, respectively. The depressed keys 1b and 1c make the associated dampers 6 spaced from the associated strings 4, and the released keys 1b and 1c permit the associated dampers 6 to be brought into contact with the associated strings 4. Thus, the dampers 6 permit the associated strings 4 to vibrate, and prohibit the strings 4 from the vibrations depending upon current positions of the associated keys 1b and 1c.

The action units 3 are arranged in the lateral direction, and are rotatably supported by a whippen rail 1j. While the black keys 1b and white keys 1c are traveling from the rest positions to the end positions, the associated capstan screw 1h gives rise to the rotation of associated action unit 3 in the counter clockwise direction about the whippen rail 1j. When the rotating action unit 3 is restricted, the action unit 3 escapes from the associated hammer 2, and the hammer starts rotation about a shank flange rail 1k. The dampers 6 are spaced from the strings 4 before the restriction, and the strings 4 get ready to vibrate. The hammers 2 are brought into collision with the strings 4 at the end of rotation, and give rise to vibrations of the associated strings 4 for producing the acoustic piano tones.

Upon collision with the strings 4, the hammers 2 are dropped onto the back check 7 of associated action units 3. When the player releases the depressed keys 1b and 1c, the hammers 2 are engaged with the action units 3, again, for repetition. When the released keys 1b and 1c reach the rest positions, the hammers 2 and action units 3 return to their rest positions as shown in FIG. 2.

The pedal system 10 is used for artistic expression. When a pianist steps on one of the pedals, the acoustic piano tones are prolonged. Another pedal makes the loudness of all the acoustic piano tones lessened, and yet another pedal makes the individual acoustic piano tone prolonged for the depressed key.

### Sequence Music Data Codes

The automatic playing is carried out on the basis of a set of sequence music data codes Dmid, and the electronic tones are produced on the basis of the sequence music data codes Dmid. A performance on the grand piano 50 is recorded in as a set of sequence music data codes Dmid if the pianist wishes it. For this reason, the sequence music data codes Dmid are hereinafter described.

The formats of sequence music data codes Dmid are defined in the MIDI protocols, and the sequence music data codes Dmid are broken down into two groups. The sequence music data codes Dmid of the first group express key events, i.e., note-on events and note-off events, and are referred to as “event data codes Smid”. On the other hand, the sequence music data codes Dmid of the second group express time period between a key event to the next key event, and are referred to as “duration data codes”.

The event data code Smid for the note-on key event is defined by a sort of key event, i.e., the note-on, a note number and a key velocity. The note-on means generation of a tone. The pitch names are respectively assigned the note numbers so that the tone to be produced is specified by the note number. The key velocity is proportional to the loudness of tones so that the loudness of tone to be produced is specified by the key velocity. On the other hand, the event data code Smid for the note-off key event is defined by a sort of key event, i.e., the note-off, and the note number. In other words, the tone to be decayed is specified by the event data code Smid for the note-off key event.

Terms “time base”, “tempo” and “delta time” relate to the time period. The time base means the number of clock pulses equivalent to a quarter note, and the tempo is indicative of the number of quarter notes per a minute. The delta time expresses the number of clock pulses between a key event and the next key event. The duration data code expresses the delta time. The tempo and time base are predetermined for a performance. The clock pulses are produced through a frequency demultiplier 15a from a system clock SCL.

The tempo and time base are assumed to be 120 and 480. Each quarter note is continued for 0.5 second, and is equivalent to 480 clock pulses. 960 clock pulses are equivalent to a second. In other words, each clock pulse is 1/960 second. Thus, the absolute time period of delta time is variable together with the tempo and time base. In case where the delta time is equivalent to 480 clock pulses, the time period from the key event to the next key event is 0.5 second.

The clock pulses per a second are hereinlater referred to as a “tempo clock signal”. When the tempo and time base are adjusted to 120 and 480, the tempo clock signal has 960 pulses per a second.

### Automatic Playing System 60

The automatic playing system 60 includes solenoid-operated key actuators 5, an information processing system 11, a pulse width modulator 12a, a memory system 16 and a touch screen 130. The information processing system 11 is shared among the automatic playing system 60, recording system 70 and muting system 80.

The information processing system 11 includes a central processing unit 11a, a read only memory 11b, which is abbreviated as “ROM”, a random access memory 11c, which is abbreviated as “RAM”, peripheral processors (not shown), data buffers (not shown) and a shared bus system 11d. The central processing unit 11a is an origin of data processing capability, and is assisted with the peripheral processors (not shown). The read only memory mainly serves as a program memory, and a computer program is stored therein. The random access memory 11c mainly serves as a working memory, and flags and registers are defined in the working memory.

One of the flags is indicative of a blocking position or a free position, which will be described in conjunction with the muting system 80. Several flags express the system 60, 70 and 80 to be activated. Other flags are assigned to options to be decided for the recording. Still other flags are used for progress in the control sequence through the subroutine programs. When a user adjusts the electronic tones and/or microphone 20 to suitable values of volume through the touch screen 130, the central processing unit 11a produces piece or pieces of control data expressing the values of volume, and the piece or pieces of control data are stored in the registers.

The central processing unit 11a, read only memory 11b, working memory 11c, peripheral processors (not shown) and data buffers (not shown) are connected to the shared bus system 11d so that pieces of music data, pieces of instruction data and pieces of control data are transferred between one of the components to another component through the shared bus system 11d.

The touch screen 130 is connected to one of the data buffers (not shown), and is a combination of a display panel and a locator. One of the peripheral processors (not shown) produces visual images on a display area of the display panel, and the locator detects a location of touch within the display area. Another peripheral processor determines the visual image touched by the user. Yet another peripheral processor is a direct memory access processor.

The computer program is broken down into a main routine program and subroutine programs. While the main routine program is running on the central processing unit, users can communicate with the information processing system 11 through the touch screen 130 so as to give their instructions to the information processing system 11, the information processing system 11 informs the users of prompt messages and current status through the display panel of touch screen 130 as will be hereinlater described. While the main routine program is running on the central processing unit 11a, pieces of data are accumulated in the random access memory, and flags are raised and taken down.

The subroutine programs are prepared for the automatic playing, recording, mute performance, solo playback and ensemble playback, and the main routine program branches to the subroutine program or subroutine programs through timer interruptions. The subroutine program for automatic playing is hereinlater described, and the subroutine program for muting performance, the subroutine program for recording, the subroutine program for ensemble playback will be described in conjunction with the muting system 80, recording system 70 and playback system 90.

Each of the solenoid-operated key actuators 5 is associated with one of the black keys 1b and white keys 1c. A slot 1n is formed in the key bed 1e, and extends under the rear portions of black keys 1b and the rear portions of white keys 1c in the lateral direction. The solenoid-operated key actuators 5 are supported by the key bed 1e, and are opposed to the lower surfaces of rear portions of keys 1b and 1c, respectively. While the solenoid-operated key actuators 5 are being energized with driving signals S1, the plungers of solenoid-operated key actuators 5 project from solenoids, and push the rear portions of associated keys 1b and 1c in the upward direction. On the other hand, when the driving signals S1 are removed from the solenoid-operated key actuators 5, the plungers are retracted into the solenoids, and the black keys 1b and white keys 1c return toward the rest position. Thus, the black keys 1b and white keys 1c are depressed and released by means of the solenoid-operated key actuators 5 instead of the thumbs and fingers of pianist.

A plunger velocity sensor (not shown) is built in each of the solenoid-operated key actuators 5. While the plunger is being moved, the plunger velocity sensor (not shown) produces a feedback signal S2, and supplies the feedback signal S2 to the information processing system 11. While the main routine program is running on the central processing unit 11a, the values of current plunger velocity are periodically fetched by the central processing unit 11a, and the series of values of current plunger velocity are accumulated in the random access memory 11c.

The means current of driving signals S1 is varied through the pulse width modulator 12a. The driving signal S1 is a pulse train, and the duty ratio of pulse train is varied through the pulse width modulator 12a. The strength of electromagnetic field is varied together with the amount of mean current of driving signal S1. Thus, the force exerted on the rear portions of keys 1b and 1c is controlled through the pulse with modulator 12a.

The memory system 16 includes a hard disk unit, and the hard disk unit has a large amount of data holding capacity. Plural sets of sequence music data codes Dmid express performances along music tunes, and are stored in the memory system 16 for automatic playing. The SMFs and RIFF files are further stored in the memory system through the recording as will be described in conjunction with the recording system 70.

While the subroutine program for automatic playing is running on the central processing unit 11a, the following functions are repeated so as to reenact a performance expressed by a set of music data codes. In detail, a set of sequence music data codes Dmid is transferred from the random access memory 11c, and, thereafter, the central processing unit 11a starts sequentially to process the sequence music data codes Dmid.

The central processing unit 11a searches the random access memory 11c for a sequence music data code Dmid or sequence music data codes Dmid to be processed. An event data code Smid for the note-on key event is assumed to be found. The central processing unit 11a specifies the black key 1b or white key 1c, which is assigned the note number identical with the note number stored in the sequence music data code, and determines a reference forward key trajectory. The reference forward key trajectory is stored in the random access memory 11c.

The reference forward key trajectory is a series of values of target key position varied with time for a depressed key 1b or 1c, and gives a value of reference key velocity to the black key 1b or white key 1c in so far as the key 1b or 1c travels thereon. The reference key velocity is the key velocity at a reference point, and is well proportional to the hammer velocity immediately before the collision between the hammer 2 and the string 4. Since the hammer velocity immediately before the collision is proportional to the loudness of acoustic piano tone, the reference key velocity is also proportional to the loudness of acoustic piano tone. In other words, the loudness of acoustic tone is controllable by adjusting the reference key velocity to the target value. Thus, the reference forward key velocity is determined for the control on the loudness of acoustic piano tone. A reference backward key trajectory is also a series of values of current key position for a released key 2b or 1c. If the released key 1b or 1c is moved on the reference backward key trajectory, the damper 6 is brought into contact with the vibrating string 4 at a note-off time, and the acoustic piano tone is decayed.

The series of values on the reference forward key trajectory are periodically read out from the random access memory 11c to the central processing unit 11a for a servo control. The central processing unit 11a calculates a value of target key velocity on the basis of values of target key position, and a value of current plunger position, which is equal to a value of current key position, on the basis of the values of current plunger velocity. Each of the values of target key position and associated value of target key velocity are compared with the value of current plunger velocity and associated value of current plunger position, and the central processing unit 11a determines a difference in position and a difference in velocity. The central processing unit further determines a target value of the mean current of driving signal S1 which makes the differences minimum, and supplies a piece of control data expressing the target value of the mean current to the pulse width modulator 12a. A block labeled with “servo controller” 12 stands for the comparison between the target key position and target key velocity and the current plunger position and current plunger velocity, determination of target value of means current and adjustment of driving signal S1 to the target value of mean current.

The servo controller 12 is periodically activated so that the solenoid-operated key actuator 5 forces the black key 1b or white key 1c to travel toward the end position. The action unit 3 escapes from the hammer 2 on the way to the end position, and the hammer 2 starts the rotation. The hammer 2 is brought into collision with the string 4 at the end of rotation, and gives rise to the vibrations of string 4. Thus, the automatic playing system 60 produces the acoustic piano tone without any fingering of a human pianist.

When the not-on key event takes place, the central processing unit 11a starts to count the tempo clocks. Upon expiry of the delta time defined in the associated duration data code, the central processing unit 11a searches the random access memory 11c for the sequence music data code Dmid to be processed. An event data code Smid for the note-off event is assumed to be found. The central processing unit 11a determines the reference backward key trajectory for the key 1b or 1c to be released. The servo controller 12 is periodically activated so that the solenoid-operated key actuator 5 forces the released key 1b or 1c to make the damper 6 bought into contact with the vibrating string 4 at a note-off time. As a result, the acoustic piano tone is decayed.

The above-described functions are repeated for the depressed keys 1b and 1c and released keys 1b and 1c until the last sequence music data code Dmid is processed.

### Muting System 80

The muting system 80 includes the information processing system 11, a motor driver 8, key sensors 9, electronic tone generator 13, a sound system 22, a hammer stopper 80a, a stepping motor 80b and the touch screen 130. The hammer stopper 80a is rotatably supported by the piano cabinet 1d, and laterally extends in a space between the array of hammers 2 and the strings 4. The hammer stopper 80a has plural cushions, and is changed between the blocking position and the free position through the rotation thereof. While the hammer stopper 80a is staying at the blocking position, the cushions enter the loci of hammers 2. For this reason, although the action units 3 escape from the hammers 2, the hammers 2 are rebound on the cushions before reaching the strings 4. Thus, the hammer stopper 80a prevents the strings 4 from the collision, and, for this reason, prohibits the strings 4 from vibrations. On the other hand, when the hammer stopper 80a is changed to the free position, the cushions are moved out of the loci of hammers 2. The hammers 2 are brought into collision with the strings 4 after the escape. Thus, the hammer stopper 80a at the free position permits the strings 4 to vibrate at the collision with the hammers 2.

The stepping motor 80b has an output shaft, which is aligned with the hammer stopper 80a, and the output shaft is connected to the hammer stopper 80a. The motor driver 8 is connected to the stepping motor 80b, and a driving signal S3 is supplied from the motor driver 8 to the stepping motor 80b. While the driving signal S3 is being supplied to the stepping motor 80b, the hammer stopper 80a is rotated between the blocking position and the free position. When the hammer stopper 80a reaches the blocking position and free position, suitable sensors supply a detecting signal S4 indicative of the arrival at the free position and another detecting signal S4 indicative of the arrival at the blocking position to the information processing system 11.

Each of the key sensors 9 is implemented by a combination of a shutter plate 9a and a photo-coupler 9b. The shutter plate 9a is connected to the lower surface of the front portion of associated key 1b or 1c, and projects from the lower surface in the downward direction. The photo-coupler 9b is provided on the key bed 1e, and radiates a light beam across the locus of the shutter plate 9a. The light beam has a cross section into which the locus of shutter plate 9a is fallen. The shutter plate 9a is moved together with the associated key 1b or 1c, and intersects the light beam. Thus, the amount of light is varied depending upon the current key position on the locus of key 1b or 1c. The key sensors 9 produce key position signals Vs representative of the current key positions, and the key position signals Vs are supplied from the key sensors 9 to the information processing system 11. While the main routine program is running on the central processing unit 11a, pieces of key position data expressing the current key positions are periodically fetched, and are accumulated in the random access memory 11c. A predetermined number of values of each piece of key position data are kept in the random access memory 11c in a first-in and first-out fashion.

The electronic tone generator 13 has a waveform memory, read-out circuits and an envelop generator, and the read-out circuits are responsive to the event data codes Smid for the note-on key event and note-off key event. When the event data code Smid for the note-on key event arrives at the electronic tone generator 13, the read-out circuit is responsive to a read-out clock signal SRD sequentially to read out pieces of waveform data from the waveform memory, and an envelope is given to the series of pieces of waveform data through the envelope generator. The read-out clock signal SRD is produced from the system clock, and is supplied from the information processing system 11 to the electronic tone generator 13. A digital internal audio signal Sdw is produced on the basis of the pieces of waveform data, and is output from the envelope generator to the sound system 22.

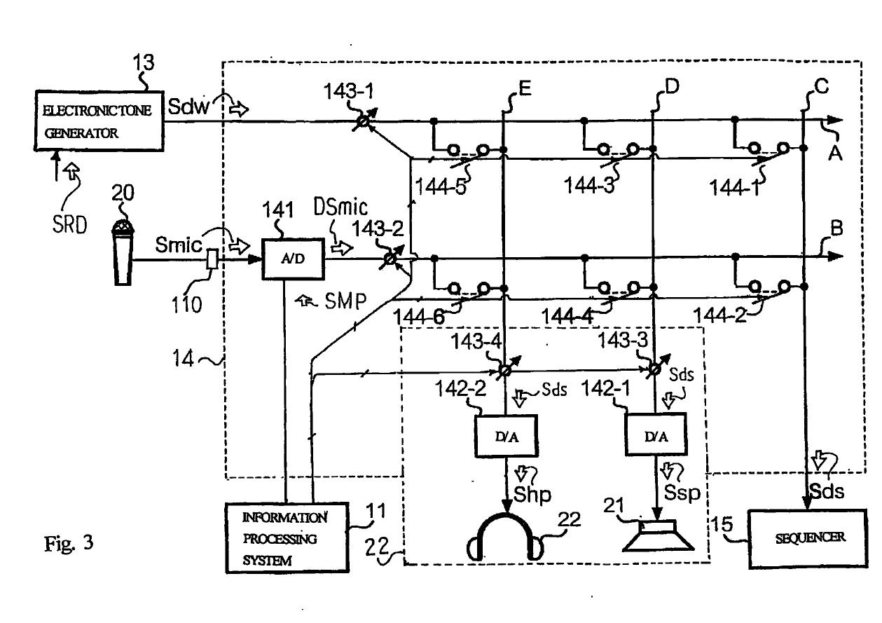

The sound system includes volume controllers 143-3, 143-4 (see FIG. 3), digital-to-analog converters 142-1, 142-2 (see also FIG. 3), loud speakers 21 and a headphone 22a. In case where the pianist selects the headphone 22a, an analog internal audio signal Shp, which is produced from the digital internal audio signal Sdw through the digital-to-analog converter 142-2, is converted to the electronic tones through the headphone 22a.

A pianist is assumed to instruct the information processing system 11 to produce the electronic tones instead of the acoustic piano tones through the touch screen 130. The pieces of instruction data are transferred to the random access memory 11c, and are stored. Then, the main routine program starts periodically to branch to the subroutine program for muting performance. The following functions are realized through the execution of subroutine program for muting performance.

First, the central processing unit 11a checks the flag to see whether or not the hammer stopper 80a has gotten to prohibit the strings 4 from collision with the hammers 2. If the flag is indicative of the blocking position, the central processing unit 11a supplies a piece of control data expressing maintenance of the blocking position to the motor driver 8 so that the motor driver 8 causes the stepping motor 80b to keep the hammer stopper 80a at the blocking position.

On the other hand, when the flag is indicative of the free position, the central processing unit 11a supplies a piece of control data expressing a change of the hammer stopper position to the motor driver 8. The motor driver 8 supplies the driving signal S3 to the stepping motor 80b, and the stepping motor 80b rotates the hammer stopper 80a from the free position to the blocking position. When the hammer stopper 80a arrives at the blocking position, the sensor (not shown) informs the information processing system 11 of the arrival at the blocking position. The central processing unit 11a changes the flag after the return to the main routine program. Thus, the hammer stopper 80a gets ready to prohibit the strings 4 from collisions with the hammers 2.

The pianist is assumed to start fingering on the keyboard 1. The depressed keys 1b and 1c give rise to the rotation of associated hammers 2 through the action units 3. However, the hammers 2 rebound on the hammer stopper 80a before reaching the strings 4. For this reason, any acoustic piano tone is not produced.

The key sensors 9 monitor the black keys 1b and white keys 1c, and continuously report the current key positions of associated keys 1b and 1c to the information processing system 11. While the main routine program is running on the central processing unit 11a, pieces of key position data, which express discrete values on the key position signals Vs, are accumulated in the random access memory 11c.

The central processing unit 11a checks the random access memory 11c to see whether or not any one of the keys 1b and 1c is depressed or released. The pianist is assumed to depress one of the black keys 1b. The central processing unit 11a notices the black key 1b being depressed through analysis on a series of values of the piece of key position data, and specifies the note number assigned to the depressed back key 1b. The central processing unit 11a calculates the key velocity from the series of values, and presumes the note-on time on the basis of the key velocity. The central processing unit 11a stores the note number and key velocity in the event data code Smid for the note-on key event.

When the note-on time comes, the event data code Smid for the note-on key event is supplied to the electronic tone generator 13. The digital internal audio signal Sdw is produced on the basis of the event data code Smid for the note-on key event, and is supplied from the electronic tone generator 13 to the sound system 22. The analog internal audio signal Shp is produced from the digital internal audio signal Sdw, and is supplied to the headphone 22a. Thus, the pianist hears the electronic tone through the headphone 22a without any disturbance to the neighborhood.

The pianist is assumed to release the depressed black key 1b. The central processing unit 11a notices the depressed black key 1b being released through the analysis on the values of key position data. The central processing unit 11a specifies the note number assigned to the released black key 1b, and presumes the note-off time on the basis of the key velocity. The central processing unit 11a stores the note number in the event data code Smid for the note-off key event. When the note-off time comes, the event data code Smid is transferred to the electronic tone generator 13. The binary values of digital internal audio signal Sdw and, accordingly, the amplitude of analog internal audio signal Shp are decayed so that the electronic tone is extinguished.

The above-described functions are repeated for all the depressed keys 1b and 1c and all the released keys 1b and 1c until the pianist completes the performance on the grand piano 50, and the pianist and/or another user hears the electronic tones instead of the acoustic piano tones.

Since the digital internal audio signal Sdw is directly produced from the pieces of waveform data, the digital audio signal Sdw does not contain any signal component of environmental noise, and, accordingly, the pianist hears the high quality electronic tones.

An interface 110 is connected to the information processing system 11, and has an MIDI interface and a plug socket. The sequential music data codes may be supplied from the information processing system 11 through the MIDI interface to another musical instrument for producing the electronic tones.

A disk driver 120 is further connected to the information processing system 11, and an information storage medium such as, for example, a CD (Compact Disk) or a DVD (Digital Versatile Disk) is loaded into and taken out from the disk driver 120.

### Recording System 70

The recording system 70 includes the information processing system 11, the memory system 16, a digital mixer 14, a microphone 20 and the sound system 22. As described hereinbefore, one of the subroutine programs is assigned to the recording, and a function, which forms an essential part of a “sequencer 15”, is realized through execution of the subroutine program. The event data codes Smid are transferred from the random access memory 11c to a data port of the central processing unit 11a, and are subjected to a data processing as the essential part of the sequencer 15.

The microphone 20 converts external sound to an analog external audio signal Smic, and the analog external audio signal Smic is supplied from the microphone 20 through the plug socket of interface 110 to the digital mixer 14. Although the interface 110 is provided for the analog external audio signal Smic, the microphone 20 is directly connected to the digital mixer 14 in FIG. 2 for the sake of simplicity. The analog-to-digital converter 141 is responsive to a sampling clock signal SMP so as to convert discrete values on the analog external audio signal Smic to a digital external audio signal DSmic. The sampling clock signal SMP is produced from the system clock.

The digital mixer 14 is further connected to the electronic tone generator 13, sound system 22 and the information processing system 11. The digital internal audio signal Sdw is supplied from the electronic tone generator 13, and the digital internal audio signal Sdw, a digital external audio signal or a digital composite audio signal Sds is supplied from the digital mixer 14 to the sound system 22 and sequencer 15 under the control of information processing system 11.

FIG. 3 shows the circuit diagram of digital mixer 14. The digital mixer 14 includes an analog-to-digital converter 141, amplifiers 143-1 and 143-2 and switches 144-1, 144-2, 144-3, 144-4, 144-5 and 144-6. The switches 144-1 to 144-6 stand for functions of the mixer 14. The switches 144-1, 144-2, 144-3, 144-4, 144-5 and 144-6 are arranged in matrix, and are selectively connected between signal propagation paths A and B and signal propagation paths C, D and E. In detail, the electronic tone generator 13 is connected through the interface 110 to the amplifier 143-1, and the amplifier 143-1 is connected through the signal propagation path A to the input nodes of switches 144-1, 144-3 and 144-5. The microphone 20 is connected through the interface 110 to the analog-to-digital converter 141, and the analog-to-digital converter 141 is connected to the amplifier 143-2, which in turn is connected through the signal propagation path B to the input nodes of switches 144-2, 144-4 and 144-6.

The output nodes of switches 144-1 and 144-2 are connected to the sequencer 15 through the signal propagation path C. The output nodes of switches 144-3 and 144-4 are connected to the volume controller 143-3 of sound system 22 through the signal propagation path D, and the output nodes of switches 144-5 and 144-6 are connected to the volume controller 143-4 of sound system 22 through the signal propagation path E. The volume controllers 143-3 and 143-4 are connected through the digital-to-analog converters 142-1 and 142-2 to the loudspeakers 21 and headphone 22, respectively.

The information processing system 11 is connected to the control nodes of switches 144-1, 144-2, 144-3, 144-4, 144-5 and 144-6. The central processing unit 11a determines what switch or switches are to be closed on the basis of the flags. The central processing unit 11a supplies pieces of control data indicative of the switch or switches to be closed to the control nodes of switches 144-1 to 144-6 so that the switches 144-1 to 144-6 are selectively opened and closed.

The information processing system 11 is further connected to the control nodes of amplifiers 143-1 and 143-2 and the control nodes of volume controllers 143-3 and 143-4. The central processing unit 11a further determines appropriate values of gain for the amplifiers 143-1 and 143-2 and the volume controllers 142-1 and 142-2 on the basis of piece or pieces of control data expressing the values of volume, and supplies pieces of control data expressing the gain to the amplifiers 143-1 and 143-2 and the volume controllers 143-3 and 143-4.

The digital mixer 14 behaves as follows. The analog external audio signal Smic is converted to a digital external audio signal DSmic through the analog-to-digital converter 141. The digital internal audio signal Sdw and digital external audio signal DSmic are regulated to an appropriate range of magnitude through the amplifiers 143-1 and 143-2, and are put on the signal propagation paths A and B. The digital internal audio signal Sdw and digital external audio signal DSmic are selectively supplied to the sequencer 15 and/or sound system 22 through mixing or without the mixing.

For example, when the pieces of control data indicate that only the switches 144-1 and 144-2 are to be closed, the signal propagation paths A and B are connected through the switches 144-1 and 144-2 to the signal propagation path C, and the digital composite audio signal Sds is produced from the digital internal audio signal Sdw and digital external audio signal DSmic. The digital internal audio signal Sdw is directly produced from the pieces of waveform data so as not to contain environmental noise component.

On the other hand, when the pieces of control data indicate that only the switch 144-2 is closed, the signal propagation path A is isolated from the signal propagation path C, and the signal propagation path B is connected to the signal propagation path C. As a result, the digital external audio signal DSmic is supplied to the sequencer 15 as the digital composite audio signal Sds.

Description is hereinafter made on the sequencer 15 with reference to FIG. 2, again. Most of the sequencer 15 is a software implementation, and the SMF and/or RIFF file is produced through the sequencer 15. In case where a user requests the information processing system 11 concurrently to record the performance on the grand piano 50 and singing, the central processing unit 11a starts to produce the event data codes Smid concurrently with the initiation of analog-to-digital conversion.

Two recording modes are prepared for users. The first recording mode is referred to as an audio recording mode, and the digital composite audio data codes are stored in the RIFF file in the audio recording mode. The event data codes Smid are not supplied from the information processing system 11 to the sequencer 15. Otherwise, the event data codes Smid are ignored by the sequencer 15.

The second recording mode is referred to as a MIDI plus audio recording mode. The duration data codes are produced in the sequencer 15 so as to be formed into a set of sequence music data codes Dmid together with the event data codes Smid, and the digital composite audio data codes and sequence music data codes are stored in the RIFF file and SMF, respectively, in the MDI plug audio recording mode.

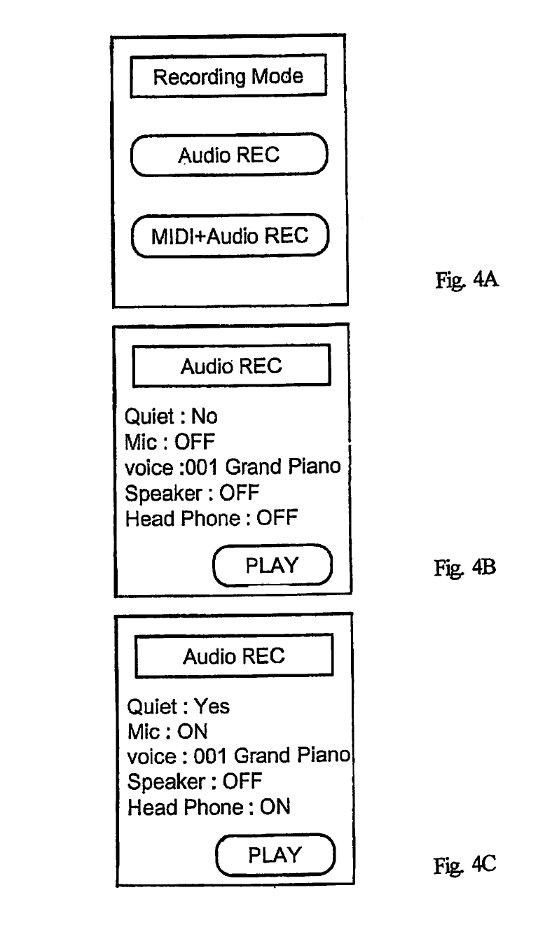

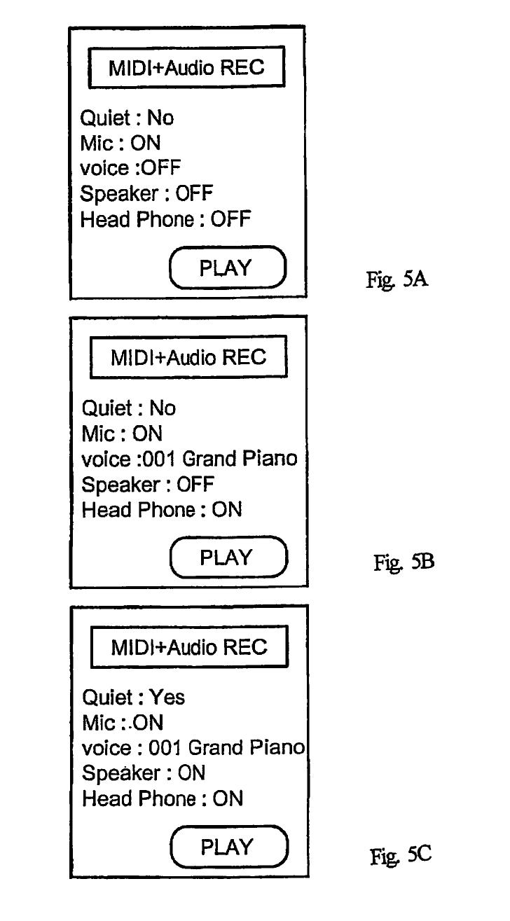

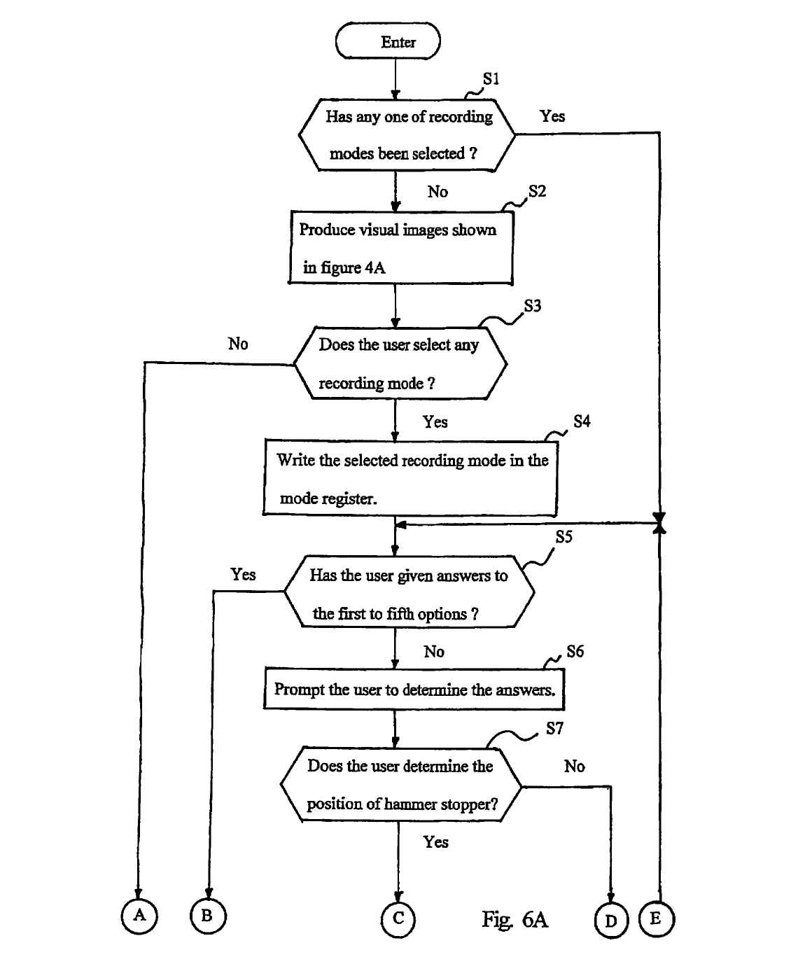

When a user selects the recording from the job menu on the touch screen 130, the visual images “Recording Mode”, “Audio REC” and “MIDI+Audio REC” are produced on the touch screen 130 as shown in FIG. 4A. The visual images “Audio REC” and “MIDI+Audio REC” are representative of the audio recording mode and the MIDI plus audio recording mode, respectively. The user has an option between the audio recording mode and the MIDI plus audio recording mode. In either recording mode, the user further has the following options, and user's selection is stored in the flags defined the random access memory 11c.

The first option is expressed as “Quiet”, which means whether or not the hammer stopper 80a is to stay at the blocking position. The user gives positive answer “Yes” or negative answer “No” to the information processing system 11 through the touch screen 130.

The second option is expressed as “MIC”, which means whether the microphone 20 is to be turned on or off. The user turns the microphone 20 on or off through the touch screen 130. When the user turns the microphone 20 on, the information processing system 11 adjusts the amplifier 143-2 to a default value, and the visual image “ON” is produced on the touch screen 130. The user can change the default value to another value which the user thinks appropriate through the touch screen 130. On the other hand, when the user turns the microphone 20 off, the information processing system 11 decreases the gain of amplifier 143-2 to zero, and the visual image “OFF” is produced on the touch screen 130.

The third option is expressed as “voice”, which means whether the digital internal audio signal Sdw is valid or invalid. Visual images of a list of tone colors are produced on the touch screen 130 for the third option. If the user does not select any tone color, the information processing system 11 makes the electronic tone generator 13 stand idle, and, accordingly, the digital internal audio signal Sdw becomes invalid. On the other hand, when the user selects one of the tone colors from the tone color list, the information processing system 11 keeps the electronic tone generator 13 active, and the digital internal audio signal Sdw is valid. When the user selects the tone color of grand piano, a visual image “001 Grand Piano” means that the electronic tones have the tone color of acoustic piano tones produced through the grand piano 50. The information processing system 11 makes the digital internal audio signal Sdw invalid by decreasing the gain of amplifier 143-1 to zero. On the other hand, when the user selects a tone color from the tone color list, the information processing system 11 adjusts the amplifier 143-1 to a default value. The user can change the gain from the default value to any value which the user thinks appropriate.

The fourth option is expressed as “Speaker”, which means whether the loudspeakers 21 are to be made active or inactive. If the user wants to hear the tones from the loudspeakers 21, the user gives positive answer to the information processing system 11 through the touch screen 130, and the information processing system 11 adjusts the gain of volume controller 143-3 to a default value. The user can change the default value to an appropriate value through the touch screen 130. A visual image “ON” is produced on the touch screen 130. On the other hand, when the user does not want to hear any tone from the loudspeakers 21, the user gives negative answer to the information processing system 11, and the information processing system 11 decreases the gain of volume controller 143-3 to zero. A visual image “OFF” is produced on the touch screen 130.

The fifth option is expressed as “Head Phone”, which means whether the headphone 22 is to be made active or inactive. If the user wants to hear the tones from the headphone 22, the user gives positive answer to the information processing system 11 through the touch screen 130, and the information processing system 11 adjusts the gain of volume controller 143-4 to a default value. The user can change the default value to an appropriate value through the touch screen 130. A visual image “ON” is produced on the touch screen 130. On the other hand, when the user does not want to hear any tone from the headphone 21, the user gives negative answer to the information processing system 11, and the information processing system 11 decreases the gain of volume controller 143-4 to zero. A visual image “OFF” is produced on the touch screen 130.

The user is assumed to give the negative answer, negative answer, negative answer and negative answer to the first option, second option, fourth option and fifth option, respectively, and select the tone color of grand piano from the tone color list. The information processing system 11 produces the visual images expressing the results of selection on the touch screen 130 as shown in FIG. 4B. When the user acknowledges the results of selection, the user touches the area of touch screen 130 where a visual image “PLAY” is produced. Then, the main routine program starts to branch to the subroutine program for the recording in the audio recording mode. The information processing system 11 keeps the hammer stopper 80a at the free position. The information processing system 11 turns the switch 144-1 on, and turns the other switches 144-2, 144-3, 144-4, 144-5 and 144-6 off. As a result, only the signal propagation path A is connected to the signal propagation path C.

While the user is fingering on the keyboard 1, the acoustic piano tones are produced through the vibrations of strings 4 and decayed, and the sequencer 15 produces RIFF audio data codes Dds from the digital composite audio signal Sds, which is equivalent to the digital internal audio signal Sdw, so as to store the RIFF audio data codes Dds in the RIFF file to be stored in the memory system 16. Since the digital internal audio data codes do not contain any environmental noise component, it is possible to reproduce noise-free music sound from the RIFF audio data codes Dds. Moreover, the pianist, who is used to playing music tunes on acoustic pianos, feels the key touch same as usual, because the action units 3 escape from the hammers 2 before the collisions between the hammers 2 and the strings 4.

The user is assumed to give the positive answer, positive answer, negative answer and positive answer to the first option, second option, fourth option and fifth option, respectively, and select the tone color of grand piano. The information processing system 11 produces the visual images expressing the results of selection as shown in FIG. 4C. When the user acknowledges the results of selection on the touch screen 130, the user touches the area of touch screen 130 where the visual image “PLAY” is produced. Then, the main routine program starts to branch to the subroutine program for the recording in the audio recording mode.

The information processing system 11 keeps the hammer stopper 80a at the blocking position. The information processing system 11 turns the switches 144-1, 144-2, 144-5 and 144-6 on, and turns the other switches 144-3 and 144-4 off. Both of the signal propagation paths A and B are connected to each of the signal propagation paths C and E. However, the signal propagation path D is isolated from the signal propagation paths A and B.

While the user is singing a song to the accompaniment of the grand piano 50, the digital internal audio signal Sdw and digital external audio signal DSmic are mixed into the digital composite audio signal Sds, and the digital composite audio signal Sds is supplied to the digital-to-analog converter 142-2 and the sequencer 15. The digital composite audio signal Sds is converted to the analog composite audio signal Shp, which in turn is converted to the electronic tones through the headphone 22. The RIFF audio data codes Dds are produced from the digital composite audio signal Sds, and are stored in the RIFF file. Since the hammer stopper 80a prevents the strings 4 from the collision with the hammers 2, the digital external audio signal DSmic does not contain any tone components expressing the acoustic piano tones. Thus, the recording system 70 can prohibit the electronic tones from being mixed with the acoustic piano tones.

A user is assumed to select the MIDI plus audio recording mode through the touch screen 130 shown in FIG. 4A. The information processing system 11 also prompts the user to give answers to the first option to the fifth option. While the recording system 70 is being active in the MIDI plug audio recording mode, the information processing system 11 always fixes the switch 144-1 to the off-state, and the digital internal audio signal Sdw is not mixed with the digital external audio signal DSmic. For this reason, the digital composite audio signal Sds is produced from only the digital external audio signal DSmic. When a user instructs the recording system 70 to store the sequence music data codes Dmid in the SMF, the event data codes Smid are supplied from the information processing system 11 to the sequencer 15, and the duration data codes are supplemented to the event data codes Smid so as to produce the sequence music data codes Dmid.

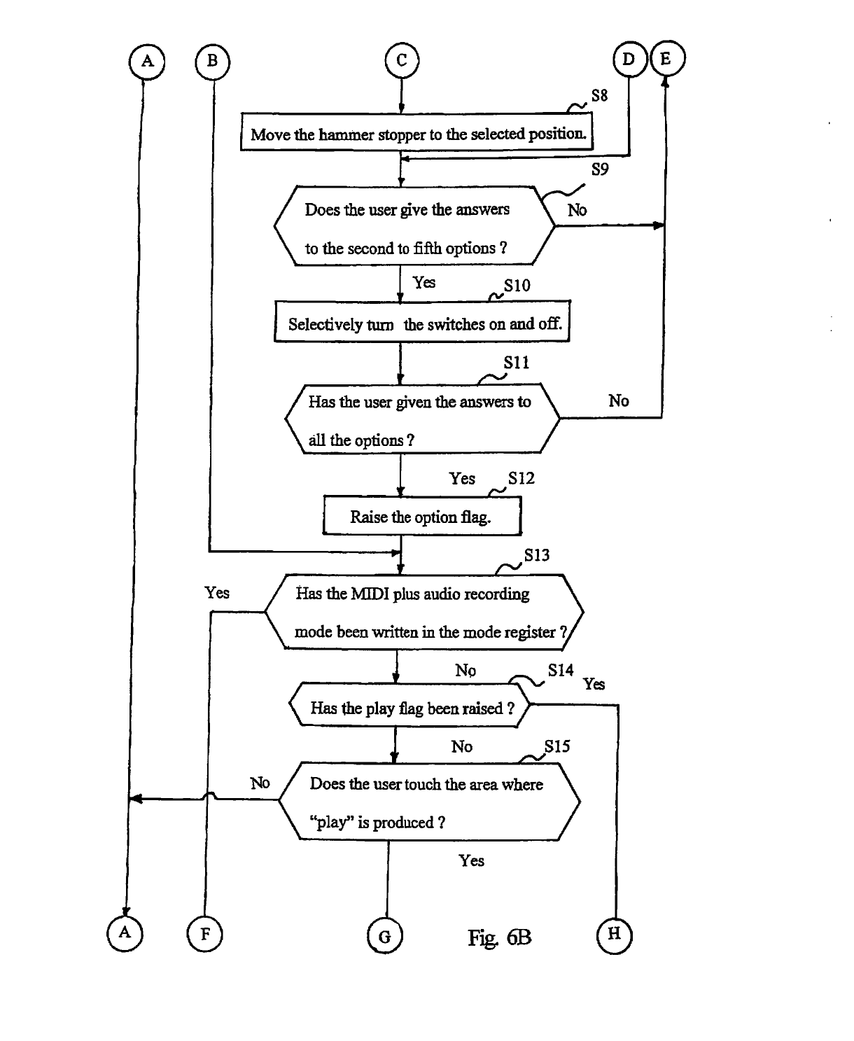

In case where the user gives the negative answers “No” and the positive answer “Yes” to the first, fourth and fifth options and the second option, respectively, and does not specify any tone color, the information processing system 11 produces the visual images shown in FIG. 5A on the touch screen 130. When the user acknowledges the results of selection, he or she touches the area of touch screen 130 where the visual image “PLAY” is produced. The main routine program starts to branch to the subroutine program for the recording.

The information processing unit 11 keeps the hammer stopper 80a at the free position. The information processing system 11 turns the switch 144-2 on, and turns the switches 144-1, 144-3 and 144-4, 144-5 and 144-6 off. The signal propagation path B is connected to the signal propagation path C. However, each of the signal propagation paths D and E is isolated from both of the signal propagation paths A and B. As a result, although the digital external audio signal DSmic is supplied through the switch 144-2 to the sequencer 15, the digital external audio signal DSmic does not reach the digital-to-analog converters 143-3 and 143-4, and any electric tones is not radiated from the loudspeakers 21 and headphone 21.

While the user is fingering a music tune on the keyboard 1, the acoustic piano tones are sequentially produced along the music tune, and the central processing unit 11 produces the event data codes Smid expressing the generation of acoustic piano tones and the decay of acoustic piano tones. Since the microphone 20 is turned on, the acoustic piano tones are converted to the analog external audio signal Smic, which in turn is converted to the digital external audio signal DSmic through the analog-to-digital converter 141. The digital audio signal DSmic passes through the switch 144-2, and is supplied from the mixer 14 to the sequencer 15. The sequencer 15 prepares the RIFF audio data codes Dds for the RIFF file.

The information processing system 11 supplies the event data codes Smid to the sequencer 15 upon production of event data codes Smid. When each of the event data codes Smid arrives at the sequencer 15, the sequencer 15 starts to count the tempo clocks. The sequencer 15 stops the increment of the number of tempo clocks at the arrival of the next event data code Smid, and produces the duration code expressing the delta time. The sequencer 15 starts to count the tempo clocks at the arrival of the next event data code Smid. Thus, the sequencer 15 measures the delta time from each of the event data codes Smid to the next event data code Smid, and produces the duration data codes. The duration data codes are supplemented to the event data codes Smid so that the sequence music data codes Dmid are prepared for the SMF.

The RIFF audio data codes Dds and sequence music data codes Dmid are respectively stored in the RIFF file and SMF. Since the switch 144-1 is turned off in the MIDI plus audio recording mode, the digital internal audio signal Sdw is not mixed into the digital external audio signal DSmic, and the acoustic piano tones and sequence music data codes are respectively stored in the RIFF file and SMF concurrently with each other.

In case where the user gives the negative answers and positive answers to the first and fourth options and the second and fifth options, respectively, and selects the tone color of ground piano from the tone color list, the information processing system 11 produces the visual images expressing the result of selection as shown in FIG. 5B. The MIDI plus audio recording mode may be desirable under the condition that the automatic player piano 100 and the microphone 20/headphone 22 are respectively prepared in compartments acoustically isolated from each other. While a pianist is playing a music tune on the automatic player piano 100, a singer hears the electronic tones through the headphone 11, and sings the song to the accompaniment of the grand piano 50. When the user acknowledges the results of selection, he or she touches the area of touch screen 130 where the visual image “PLAY” is produced. The main routine program starts periodically to branch to the subroutine program for the recording.

The information processing system 11 keeps the hammer stopper at the free position. The information processing system 11 turns the switches 144-1, 144-3 and 144-4 off, and turns the switches 144-2, 144-5 and 144-6 on. As a result, the signal propagation path B is connected to both of the signal propagation paths C and E, and the signal propagation path D is isolated from the signal propagation path B. The signal propagation path A is connected to the signal propagation path E, and is disconnected from all of the signal propagation paths C and D.

While the pianist is fingering the music tune on the keyboard 1, the acoustic piano tones are produced through the vibrations of strings 4, and the pianist hears the acoustic piano tones. The information processing system 11 produces the event data codes Smid, and the event data codes Smid are supplied to the electronic tone generator 13. As a result, the digital internal audio signal Sdw is produced on the basis of the event data codes Smid. The event data codes Smid are further supplied from the information processing system 11 to the sequencer 15. The acoustic piano tones do not reach the microphone 20 by virtue of the compartments acoustically isolated from one another. The voice of singer is converted to the analog external audio signal Smic, and is converted to the digital external audio signal DSmic. The digital internal audio signal Smid and digital external audio signal Sdw are mixed into the digital composite audio signal Sds, and the singer hears both of the electronic tones and voice through the headphone 22. The digital external audio signal DSmic is further supplied from the mixer 14 to the sequencer 15 as the digital composite audio signal Sds.

The sequencer 15 supplements the duration data codes to the event data codes, and stores the sequence music data codes into the SMF. The sequencer 15 produces the RIFF audio data codes from the digital composite audio signal Sds, and stores the RIFF audio data codes into the RIFF file. Thus, the SMF and RIFF file are concurrently produced.

In case where the user gives the positive answers to the first, second, fourth and fifth options and selects the tone color of grand piano from the tone color list for the third option, the information processing system 11 produces visual images shown in FIG. 5C on the touch screen 130. The MIDI plus audio recording mode shown in FIG. 5C may be desirable for the pianist and a singer who are performing and singing in compartments acoustically isolated from each other. While the singer is singing a song to the microphone 20 in the acoustically isolated compartment, he or she hears the electronic tones expressing both of the acoustic piano tones and his or her voice through the headphone 22a, and the pianist hears the electronic tones expressing both of the acoustic piano tones and singer's voice through the loudspeakers 21.

The information processing system 11 changes the hammer stopper 80a to the blocking position. The information processing system 11 turns the switches 144-2, 144-3, 144-4, 144-5 and 144-6 on, and turns the switch 144-1 off.

While the singer is singing to the accompaniment of automatic player piano 100, the information processing system 11 supplies the digital internal audio signal Smid expressing the event data codes Smid to both of the electronic tone generator 13 and sequencer 15, and the digital external audio signal DSmic is supplied from the microphone 20 to both of the loudspeakers 21 and headphone 22 through the mixer 14. Since the hammer stopper 80a is staying at the blocking position, any acoustic piano tones are not produced through the vibrations of strings 4.

The sequencer 15 supplements the duration data codes to the event data codes, and the sequence music data codes are stored in the SMF. The sequencer 15 further produces the RIFF audio data codes Dds from the digital composite audio signal Sds, and the RIFF audio data codes Dds are stored in the RIFF file.

The digital internal audio signal Sdw and the digital external audio signal Dmic are transferred from the signal propagation paths A and B to the signal propagation paths D and E, and are mixed into the digital composite audio signal Sds. The digital composite audio signal Sds is converted to the analog audio signals Ssp and Shp, and the analog audio signals Ssp and Shp are converted to the electronic tones through the loudspeakers 21 and headphone 22. However, only the digital external audio signal DSmic is transferred from the signal propagation path B to the signal propagation path C. For this reason, the digital composite audio signal Sds expresses singer's voice, only.

The SMF and RIFF files are stored in the memory system 16. When a user wants to duplicate the SMF and RIFF files to the information storage medium, the SMF and RIFF files are transferred from the memory system 16 to the disk driver 120.

### Subroutine Program for Recording

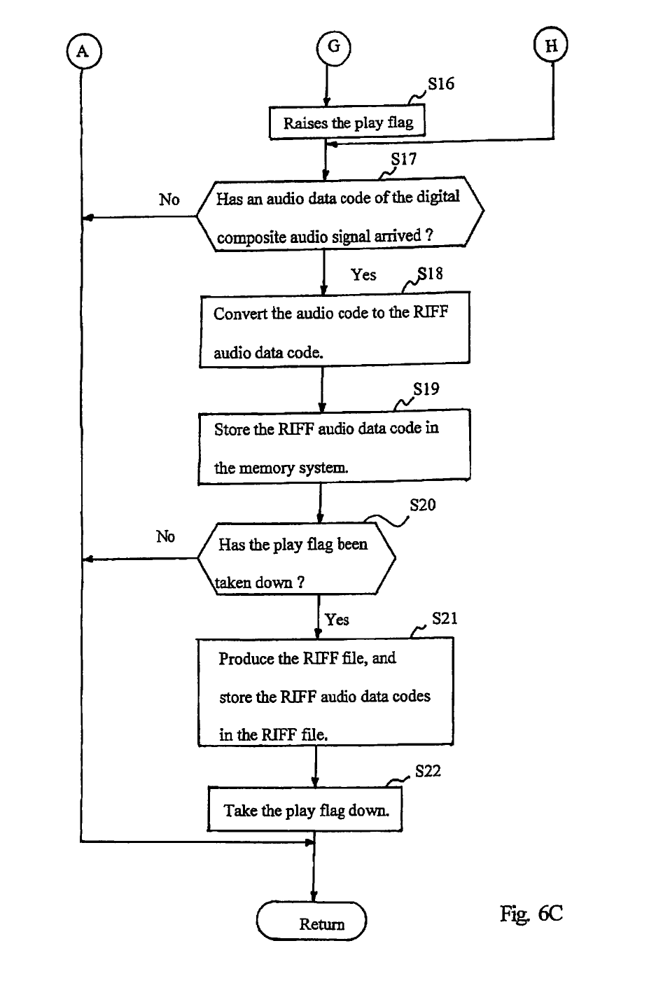

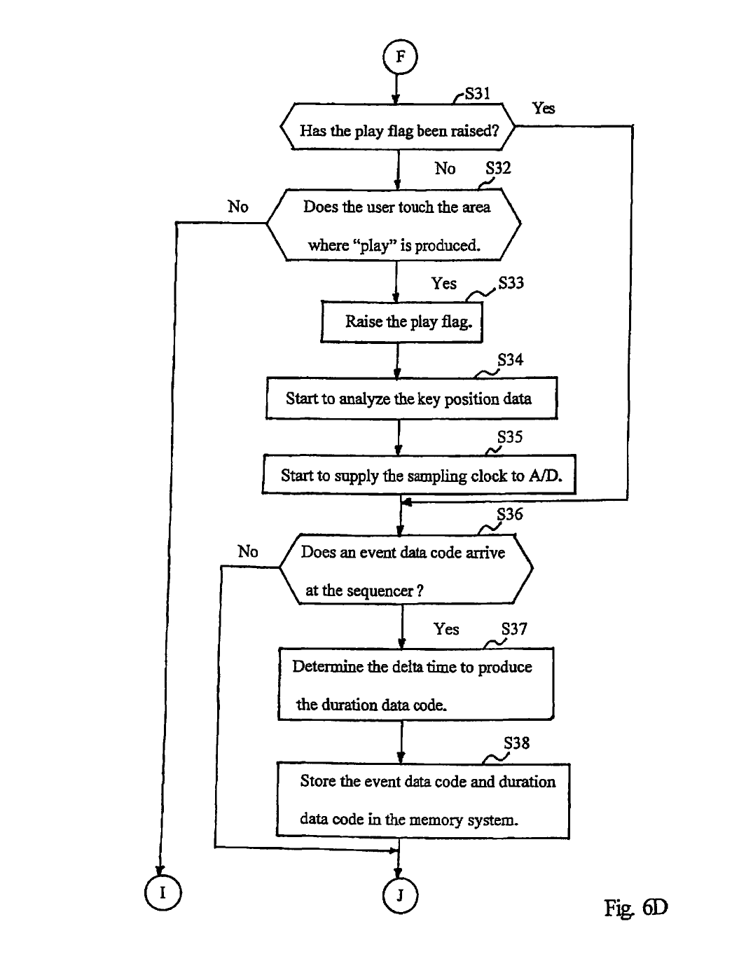

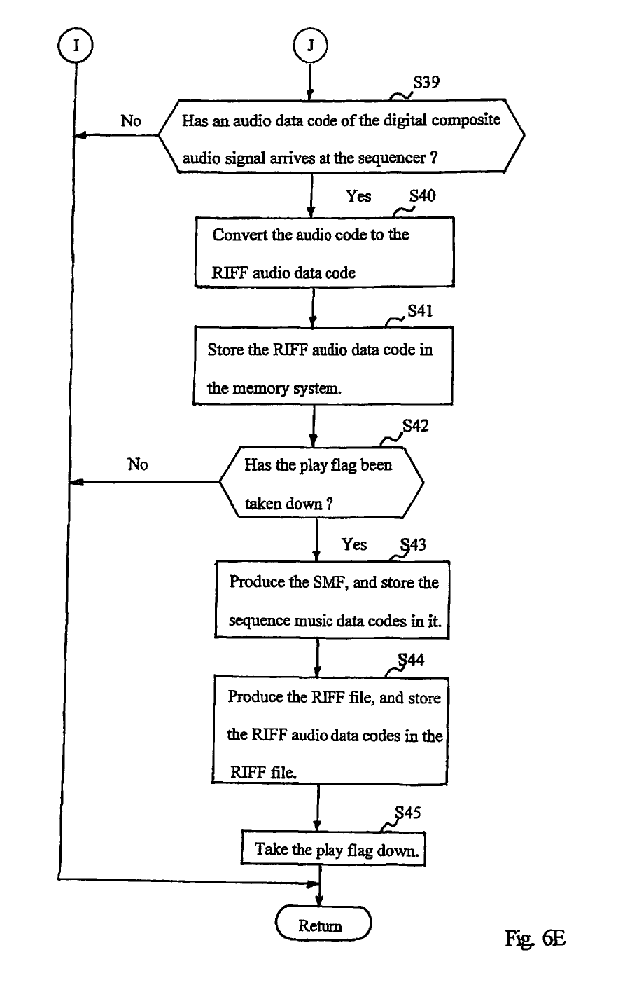

FIGS. 6A to 6E shows a sequence of essential jobs of the subroutine program for the recording. When a user selects the recording from the job menu, the central processing system 11a raises the flag expressing the recording system 70, the main routine program periodically branches the subroutine program for recording through timer interruptions. If the user cancels the request for recording, the main routine program does not branch to the subroutine program.

The central processing unit 11a checks the mode register to see whether or not any sort of recording mode has been written as by step S1. If the audio recording mode or MIDI plus audio recording mode is written in the mode register, the answer at step S1 is given affirmative “Yes”, and proceeds to step S5. On the other hand, if any one of the recording modes is not written in the mode register, the answer is given negative “No”, and the central processing unit 11a produces the visual images shown in FIG. 4A so as to prompt the user to select one of the recording mode as by step S2.

Subsequently, the central processing unit 11a checks the working memory to see whether or not the user touch any one of the areas where the recording modes are produced as by step S3. While the user is not touching both areas, the answer is given negative “No”, and the central processing unit 11a immediately returns to the main routine program. Thus, the central processing unit 11a reiterates the loop consisting of steps S1 to S3 until the user selects one of the recording modes on the touch screen 130.

When the user selects one of the recording modes on the touch screen 130, the central processing unit 11a acknowledges user's selection during the execution in the main routine program. After entry into the subroutine program, the answer at step S3 is given affirmative “Yes”, and the central processing unit 11a writes the selected recording mode in the mode register as by step S4. The central processing unit 11a proceeds to step S5. As described hereinbefore, when the answer at step S1 is given affirmative “Yes”, the central processing unit 11a proceeds to step S5 without execution at steps S2, S3 and S4.

The central processing unit 11a checks the option flag to see whether or not the user has given the answers to the first to fifth options at step S5. While the user is giving the answers to the first to fifth options, the answer at step S5 is given negative “No”. With the negative answer, the central processing unit 11a produces visual images for each of the options on the touch screen, and prompts the user to give his or her answers as by step S6.

Subsequently, the central processing unit 11a checks the working memory 11c to see whether or not the user gives the answer to the first option as by step S7. While the user does not enter the answer to the first option, the answer at step S7 is given negative “No”. With the negative answer at step S7, the central processing unit 11a proceeds to step S9, and checks the working memory 11c to see whether or not the user enters the answers to the second to fifth options at step 9. While the user is having the options under consideration, the answer at step S9 is given negative “No”, and the central processing unit 11a returns to step S5.

If the central processing unit 11a acknowledges the answer to the first option or the answers to the second to fifth options, the answer at step S7 or S9 is given affirmative “Yes”. When the user firstly gives the answer to the first option, the central processing unit 11a proceeds to step S8, and the central processing unit 11a instructs the motor driver 8 to change the hammer stopper 80a to the free position or blocking position to be requested by the user through the rotation of electric motor 80b. When the user first gives the answers to the second to fifth options, the central processing unit 11a proceeds to step S10, and selectively turns the switches 144-1 to 144-6 on and off. In either case, the answer at step S11 is given negative “No”, and the central processing unit 11a returns to step S5. Thus, the central processing unit 11a reiterates the loop consisting of steps S5 to S11 until the completion of answers to the first to fifth options.

When the user gives the answers to all the options, the answer at step S11 is changed to affirmative “Yes”. Then, the central processing unit 11a raises the option flag as by step S12. Even if the central processing unit 11a returns to step S1, the answer at step S5 is given affirmative “Yes” so as to prohibit the central processing unit 11a from the entry into the loop consisting of steps S6 to S12. If the user wishes to change the answer to any one of the first to fifth options, he or she takes down the option flag on the touch screen 130. Then, the central processing unit 11a enters the loop, again, and the user can change the answer or answers.

When the answer at step S5 is given affirmative “Yes”, or when the job at step S12 is completed, the central processing unit 11a checks the mode flag to see whether or not the user has selected the MIDI plug audio recording mode as by step S13. If the user has selected the MIDI plus audio recording mode, the central processing unit 11a proceeds to step S31. On the other hand, if the user has selected the audio recording mode, the central processing unit 11a proceeds to step S14.

The user is assumed to have selected the audio recording mode. The central processing unit 11a checks the play flag to see whether or not the user has touched the visual image “play” as by step S14. The answer at step S14 is given negative “No” immediately after the selection of audio recording mode, and the central processing unit 11a checks the random access memory 11c to see whether or not the user touched the visual image “play” between the previous timer interruption and the present timer interruption as by step S15. While the user is rendering the visual image “play” untouched, answer at steps S14 and S15 are given negative “No”, and the central processing unit 11a returns to the main routine program.

When the user gets ready for the recording, he or she touches the visual image “play”. Then, the answer at step S15 is changed to affirmative “Yes”. With the positive answer “Yes”, the central processing unit 11a raises the play flag as by step S16, and checks the random access memory 11c to see whether or not an audio data code of the digital composite audio signal Sds arrives at the sequencer 15 as by step S17. While any audio data code is not finding, the answer at step S17 is given negative “No”, and the central processing unit 11a returns to the main routine program. Thus, the central processing unit 11a reiterates the loop consisting of steps S1, S5, S13, S14 and S17 until arrival of the composite audio signal Sds.

When the composite audio signal Sds arrives at the sequencer 15, the answer at step S17 is changed to affirmative “Yes”. The central processing unit 11a converts the audio data code to the RIFF audio data code as by step S18, and store the RIFF audio data code in the memory system 16 as by step S19.

The central processing unit 11a checks the random access memory 11c to see whether or not the play flag is taken down as by step S20. While the user is continuing the recording, the answer is given negative “No”, and the central processing unit 11a returns to the main routine program. Thus, the central processing unit 11a reiterates the loop consisting of steps S1, S5, S13, S14 and S17 to S20 so as to store the RIFF audio data codes in the memory system 16.

When the user finishes the recording, he or she takes the play flag down through the touch screen 130. Then, the answer at step S20 is changed to affirmative “Yes”, and the central processing unit 11a produces the RIFF file so as to store the RIFF audio data codes in the RIFF file as by step S21. Thereafter, the central processing unit 11a takes the play flag down as by step S22. Even if the user does not change the automatic player piano 100 from the recording to another job, the central processing unit 11a merely reiterates the loop consisting of steps S1, S5, S13, S14 and S15.

The user is assumed to select the MIDI plus audio recording mode. The central processing unit 11a proceeds from steps S13 to S31. The central processing unit 11a checks the play flag to see whether or not the user has touched the visual image “play” as by step S31. The answer at step S31 is given negative “No” immediately after the selection of MIDI plus audio recording mode, and the central processing unit 11a checks the random access memory 11c to see whether or not the user touched the visual image “play” between the previous timer interruption and the present timer interruption as by step S32. While the user is rendering the visual image “play” untouched, answer at steps S31 and S32 are given negative “No”, and the central processing unit 11a returns to the main routine program.

When the user gets ready for the recording, he or she touches the visual image “play”. Then, the answer at step S32 is changed to affirmative “Yes”. With the positive answer “Yes”, the central processing unit 11a raises the play flag as by step S33, and proceeds to step S34.

As described hereinbefore, the pieces of key position data are periodically fetched from the data buffer, and are accumulated in the random access memory 11c. The central processing unit 11a starts to analyze the pieces of key position data at step S34, and starts to supply the sampling clock to the analog-to-digital converter 141 so as to produce the digital composite audio signal Sds as by step S35. Thus, the sequencer 15 starts the production of sequence music data codes concurrently with the production of RIFF audio data codes.

Subsequently, the central processing unit 11a checks the random access memory 11c to see whether or not an event data code is produced through the analysis as by step S36. If the user does not start the fingering, all the keys 1b and 1c stay at the rest position, and any event data code is not produced. In this situation, the answer at step S36 is given negative “No”. With the negative answer, the central processing unit 11a proceeds to step S39, and checks the random access memory 11c to see whether or not an audio data code of digital composite audio signal Sds. If any audio data code is not found, the central processing unit 11a returns to the main routine program. Thus, the central processing unit 11a reiterates the loop consisting of steps S1, S5, S13, S31, S36 and S39 until either event data code or audio data code is found in the random access memory 11c.

When the central processing unit 11a finds an event data code, the answer at step 36 is changed to affirmative “Yes”, and the central processing unit 11a reads the lapse of time on the timer. The central processing unit 11a determines the delta time, and produces the duration data code as by step S37. When the first event data code for the note-on is produced, the delta time is zero, because any previous event data code does not exist. The central processing unit 11a stores the event data code and duration data code in the random access memory 11c as by step S38.

When an audio data code of the digital composite audio signal Sds arrives at the sequencer 15, the answer at step S39 is changed to affirmative “Yes”. The central processing unit 11a converts the audio data code to the RIFF audio data code as by step S40, and store the RIFF audio data code in the memory system 16 as by step S41. The central processing unit 11a checks the random access memory 11c to see whether or not the play flag is taken down as by step S42.

While the user is continuing the recording, the answer at step S42 is given negative “No”, and the central processing unit 11a returns to the main routine program. Thus, the central processing unit 11a reiterates the loop consisting of steps S1, S5, S13, S31, S36 to S38 and S39 to S42 so as to store the sequence music data codes and RIFF audio data codes in the memory system 16, separately.

When the user finishes the recording, he or she takes the play flag down through the touch screen 130. Then, the answer at step S42 is changed to affirmative “Yes”. With the positive answer, the central processing unit 11a produces the SMF and RIFF file so as separately to store the sequence music data codes and RIFF audio data codes in the SMF and RIFF file as by steps S43 and S44. Thereafter, the central processing unit 11a takes the play flag down as by step S45. Even if the user does not change the automatic player piano 100 from the recording to another job, the central processing unit 11a merely reiterates the loop consisting of steps S1, S5, S13, S31 and S32.

As will be understood from the foregoing description, the central processing unit 11a concurrently starts and finishes the production of SMF and RIFF file.

### Playback System 90

The playback system 90 includes the information processing system 11, electronic tone generator 13, mixer 14, memory system 16, sound system 22, interface 110, disk driver 120 and touch screen 130.

When a user instructs the information processing system 11 to reproduce a solo performance, an SMF or a RIFF file is transferred from the disk driver 120 to the random access memory 11c, and the event data codes or RIFF audio data codes are supplied from the random access memory 11c through the electronic tone generator 13 and mixer 14 or the mixer 14 to the sound system 22.

A set of sequential music data codes may be transferred from the disk driver 120 to the hard disk 16 or random access memory 11c so as to reproduce the music tune through the electronic tones. In this situation, the electronic tones may be radiated from the loud speakers 21 for listeners.

The performances are reproduced in ensemble on the basis of the sequence music data codes and RIFF audio data codes respectively stored in the SMF and RIFF file in various ways. For example, both of the performances may be reproduced through the electronic tones. Otherwise, the automatic playing system 60 selectively drives the solenoid-operated key actuators 5 so as to produce the acoustic piano tones on the basis of the sequence music data codes, and the electronic tones are reproduced through the sound system 22 from the RIFF audio data codes. The conditions in playback are same as those in the recording, and the information processing system 11 concurrently starts to process the sequence music data code and the RIFF audio data codes. The song and accompaniment are reproduced in good ensemble.

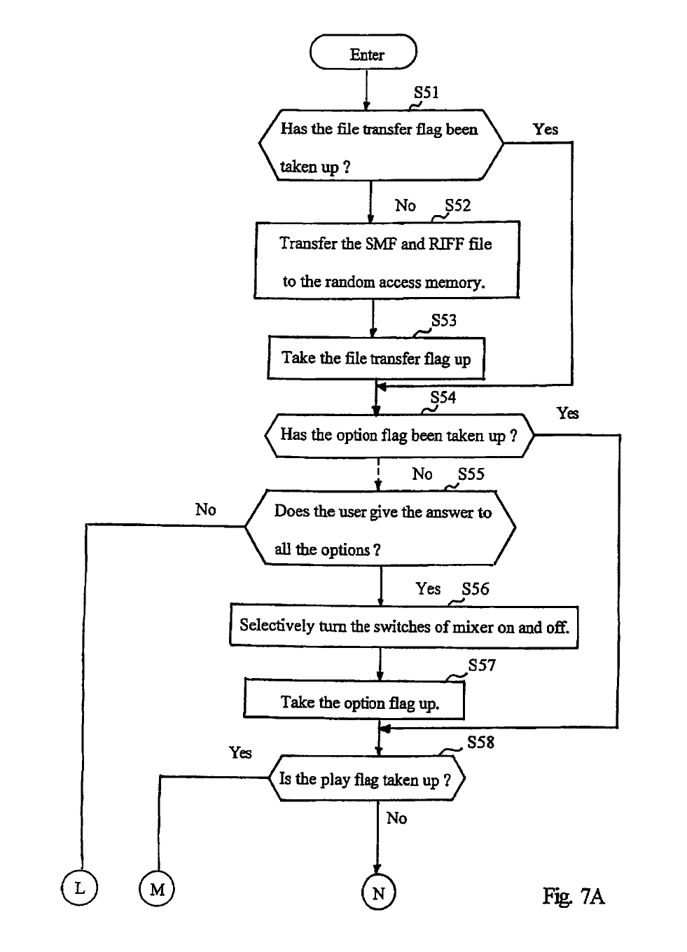

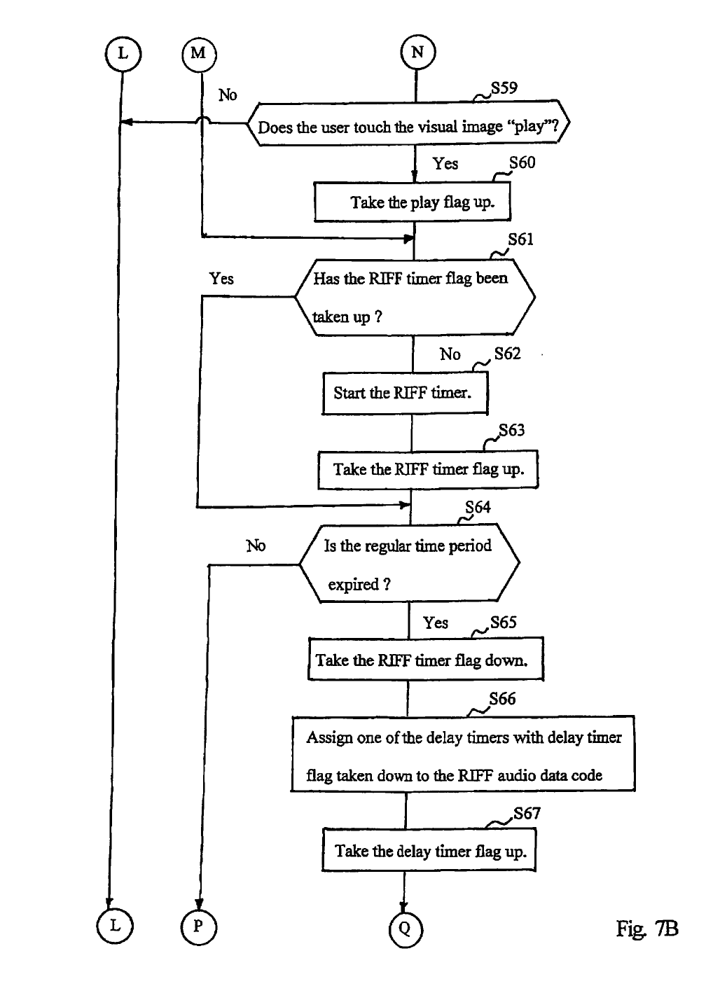

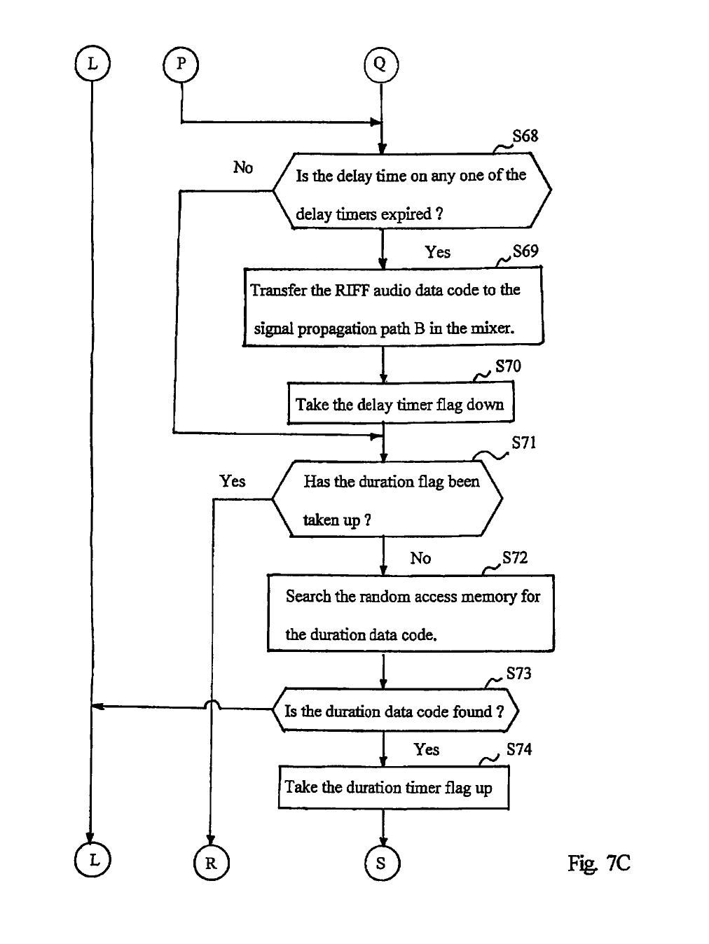

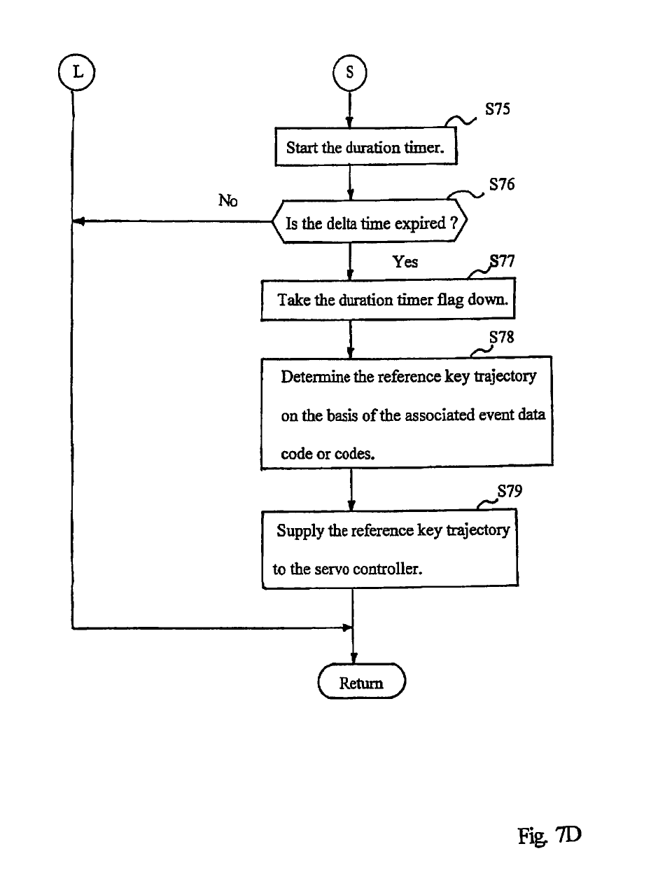

FIGS. 7A to 7D show a sequence of jobs in the subroutine program for ensemble playback. Plural software timers are prepared for the ensemble playback, and are periodically incremented. When the user selects the ensemble playback from the job menu on the touch screen 130, the main routine program starts periodically to branch to the subroutine program for the ensemble playback. The central processing unit 11a checks the file transfer flag in the random access memory 11c to see whether or not the SMF and RIFF file have been transferred to the random access memory 11c as by step S51. If the SMF and RIFF file have not been transferred to memory system 16 to the random access memory 11c, yet, the file transfer flag is taken down, and the answer at step S51 is given negative “No”. Then, the central processing unit 11a instructs one of the peripheral processors to transfer the SMF and RIFF file from the memory system 16 to the random access memory 11c as by step S52, and takes the file transfer flag up as by step S53. As a result, when the main routine program branches to the subroutine program through the next timer interruption, the answer at step S51 is given affirmative “Yes”, and the central processing unit 11a proceeds to step S54 without execution at steps S52 and S53.

The central processing unit 11a checks the option flag to see whether or not the user has given the answers to the first to fifth options at step S54. While the user is having the options under consideration, the answer at step S54 is given negative “No”, and the waits for the completion as similar to the loop consisting of Steps S5 to S9. When the user acknowledges his or her answers, the answer at step S55 is changed to affirmative “Yes”. With the positive answer, the central processing unit 11a selectively turns the switches 144-1 to 144-6 on and off as by step S56, and takes the option flag up as by step S57. Since the acoustic piano tones are produced through the automatic playing system 60, the switches 144-1, 144-2, 144-3 and 144-5 are turned off, and the switches 144-4 and 144-6 selectively turn on and off depending upon the answers to the fourth and fifth options. After the acknowledgement, the answer at step S54 is changed to affirmative “Yes”, and the central processing unit 11a proceeds from step S54 to step S58 without execution at steps S55, S56 and S57 in so far as the user does not cancel the acknowledgement.

Subsequently, the central processing unit 11a checks the play flag to see whether or not the user has already instructed the initiation of playback at step S58. While the user is preparing for the ensemble playback, the answer at step S58 is given negative “No”, and the central processing unit 11a checks the random access memory 11c to see whether or not the user touches the visual image “play” between the previous timer interruption and the present timer interruption as by step S59. If the user has not touched the visual image “play”, yet, the answer at step S59 is given negative “No”, and returns to the main routine program. Thus, the central processing unit 11a reiterates the loop consisting of steps S51, S54, S58 and S59, and waits for the touch on the visual image “play”.

When the user gets ready to hear the ensemble playback, he or she touches the visual image “play”, and the answer at step S59 is changed to affirmative “Yes”. Then, the central processing unit 11a takes the play flag up as by step S60. For this reason, when the main routine program branches to the subroutine program for ensemble playback through the next timer interruption, the answer at step S58 is given affirmative “Yes”, and the central processing unit 11a proceeds to step S61 without execution at steps 59 and 60.

The RIFF audio data codes are to be supplied to the sound system 22 at regular intervals, which is equal to the time intervals during the recording, and the regular time intervals are measured by means of the RIFF audio data codes. When the user touches the visual image “play”, the RIFF timer stands idle, and the RIFF timer flag is maintained low. For this reason, the answer at step S61 is given negative “No”, and the central processing unit 11a starts the RIFF timer as by step S62. The central processing unit 11a takes the RIFF timer flag up as by step S63. As a result, while the regular time interval is not being expired, the answer at step S61 is given affirmative “Yes”, and the central processing unit 11a proceeds to step S64 without execution at steps S62 and S63.

Subsequently, the central processing unit 11a checks the RIFF timer to see whether or not the lapse of time is equal to the regular time interval as by step S64. While the lapse of time is being shorter than the regular time interval, the answer at step S64 is given negative “No”, the central processing unit 11a proceeds to step S68. The central processing unit 11a checks the delay timers to see whether or not a delay time on any one of the delay timers is expired at step S68. If the lapse of time on all the delay timers is not expired, the central processing unit 11a proceeds to step S71 so as to process the sequence music data codes through the loop consisting of steps S71 to S77. Thus, the central processing unit 11a reiterates the loop consisting of steps S51, S54, S58, S61, S64 and S68 until change of answer at step S64 or S68.

The regular time interval is assumed to be expired. The answer at step S64 is changed to affirmative “Yes”. Then, the central processing unit 11a takes the RIFF timer flag down as by step S65, and assigns one of the idling delay timers to the RIFF audio data code as by step S66. Thus, the RIFF audio data codes are not supplied to the mixer 22 upon expiry of regular time intervals.

A reason why the delay timers are prepared for the RIFF audio data codes is that a mechanical delay is unavoidably introduced between the initiation of servo control and the generation of acoustic piano tone. The mechanical delay is consumed by the movements of plungers, action units 3 and hammers 2. In other words, although the RIFF audio data codes immediately converted to the electronic tones without any substantial delay, the event data codes result in the generation of acoustic piano tones and the decay of acoustic piano tones after the mechanical delay. In order concurrently to produce the acoustic piano tones and electronic tones on the condition that the event data codes and RIFF audio data codes are concurrently delivered to the servo controller 12 and mixer 22, the delay time, which is equal to the mechanical delay, is to be introduced between the expiry of regular time interval and the delivery to the mixer 22. In this instance, the delay time period is 0.5 second. However, the delay time period is varied depending upon the model of grand piano 50. The regular time intervals are much shorter than the delay time period so that plural delay timers are prepared for the RIFF audio data codes.

When the RIFF audio data code is assigned to the idling delay timer, the delay timer flag, which is associated with the delay timer, is taken up as by step S67. As a result, the delay timer assigned to the RIDD audio data code is not assigned to the other RIFF audio data codes until the delay timer flag is taken down.

When the delay time period is expired, the answer at step S68 is changed to affirmative “Yes”. Then, the central processing unit 11a transfers the RIFF audio data code to the signal propagation path B in the mixer 14 as by step S69, and takes the delay timer flag down as by step S70. Thus, the central processing unit 11a reiterates the loop consisting of steps S61 to S70 so as to supply the RIFF audio data codes through the mixer 14 to the sound system 22.

When the central processing unit 11a proceeds to step S71, the sequential music data codes are processed. In detail, the central processing unit 11a checks the duration flag to see whether or not the tempo clocks have been already counted as by step S71. When the user touches the visual image “play”, the duration flag is taken down, and the answer at step S71 is given negative “No”. The central processing unit 11a searches the random access memory 11c for the duration data code to be processed as by step S72. When the duration data code to be processed is found, the answer at step S73 is given affirmative “Yes”. With the positive answer “Yes”, the central processing unit 11a takes the duration timer flag up as by step S74, and starts the duration timer as by step S75. While the duration timer is increasing the tempo clocks, the answer at step S76 is given negative “No”, and the central processing unit 11a returns to the main routine program. Thus, the central processing unit 11a is reiterating the loop consisting of steps S51, S54, S58, S61, S64, S68, S71 and S76 until the change of answer at step S76.

When the duration timer indicates the number of tempo clocks equal to that stored in the duration data code, the answer at step S76 is given affirmative “Yes”. With the positive answer “Yes”, the central processing unit 11a takes the duration flag down as by step S77 so as to search the random access memory 11c for the next duration code at step S72, and determines the reference key trajectory, i.e., either reference forward key trajectory or reference backward key trajectory as by step S78. The reference key trajectory is supplied to the servo controller 12 as by step S79 so that the key 1b or 1c is forced to travel along the reference key trajectory. Thus, any delay time is not introduced between the determination of reference key trajectory and the supply to the servo controller 12.

As will be understood from the foregoing description, the recording system 70 processes both of the event data codes and digital composite audio signal Sds by means of the single information processing system 11. As a result, either of or both of the SMF and RIFF file are produced through the data processing.

Moreover, the central processing unit 11a concurrently starts the analysis on the pieces of key position data and the production of digital composite audio signal Sds. (See FIG. 6D, steps S34 and S35.) The sequence music data codes, which express the performance on the grand piano 50, are produced in parallel to the production of RIFF audio data codes expressing singer's voice and/or the electronic tones. When the user wants to reproduce the performance and singer's voice in synchronization with each other, the ensemble playback is carried out on the conditions same as those in the recording, and starts concurrently to process the RIFF audio data codes and the sequence music data codes at the touch on the visual image “play” on the touch screen 130. (See FIG. 7B, steps S59 and S60.) As a result, the performance and singer's voice are reproduced in good ensemble.

The digital internal audio signal Sdw and digital external audio signal DSmic are selectively produced into the digital composite audio signal Sds by virtue of the switches 144-1 to 144-6, and the event data codes are directly supplied to the sequencer 15. For this reason, various sorts of audio files are obtained together with the SMF.

### Second Embodiment

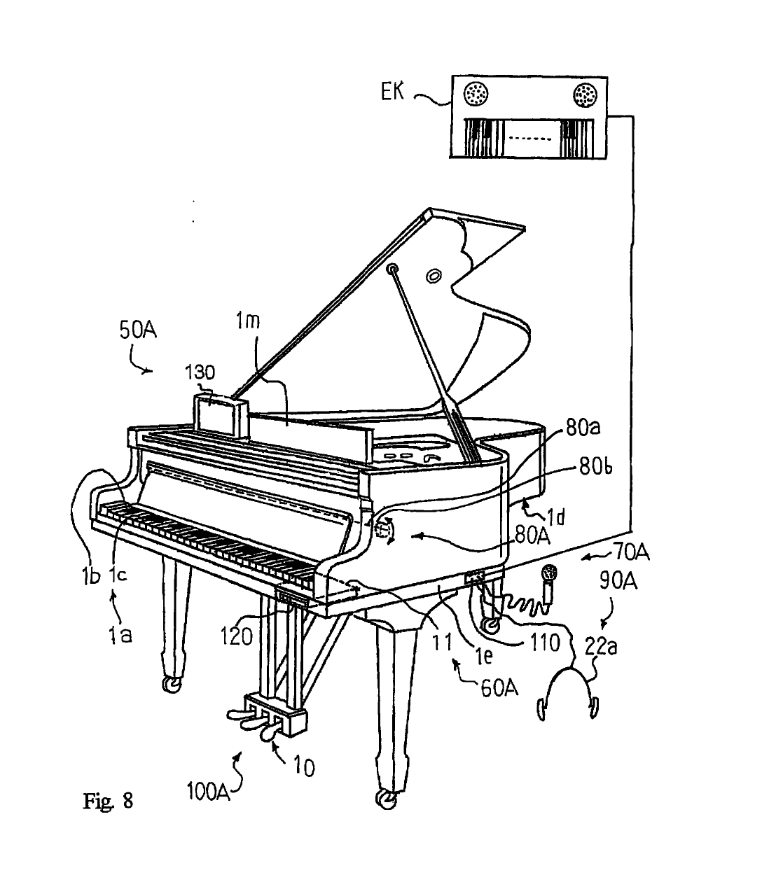

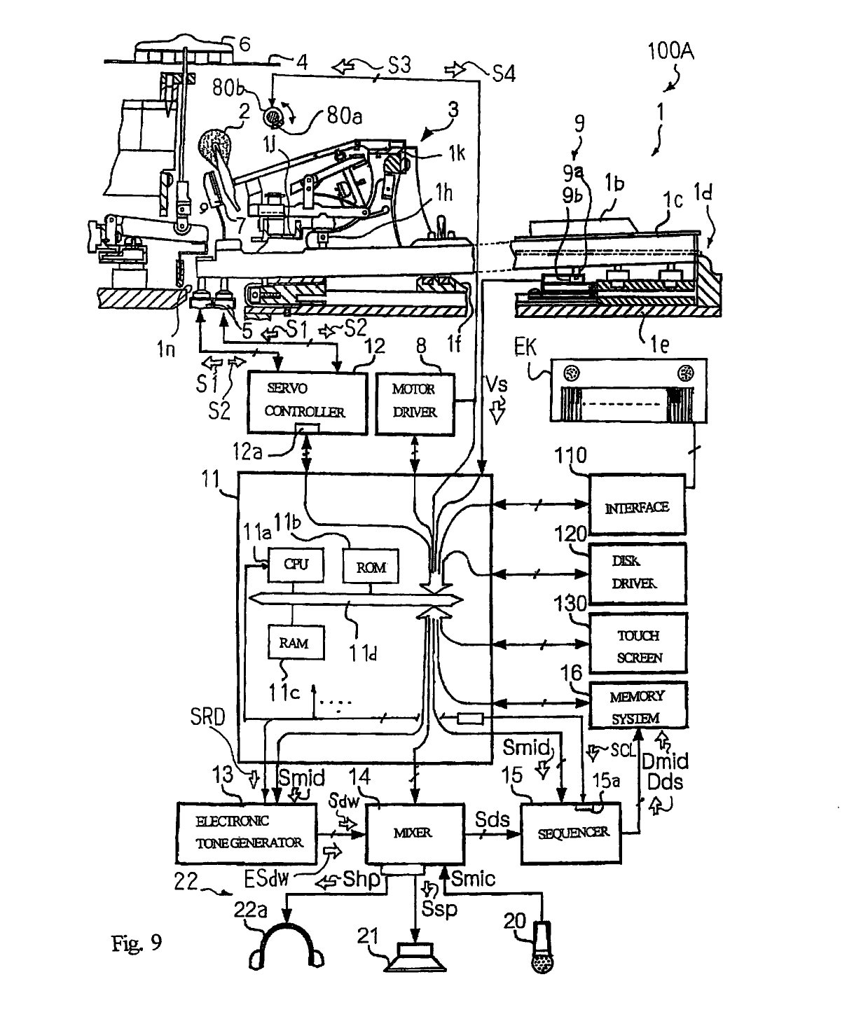

Turning to FIGS. 8 and 9 of the drawings, another automatic player piano 100A embodying the present invention comprises a grand piano 50A, an automatic playing system 60A, a recording system 70A, a muting system 80A and a playback system 90A. The grand piano 50A, automatic playing system 60A, muting system 80A and playback system 90A are respectively similar to the grand piano 50, automatic playing system 60, muting system 80 and playback system 90. For this reason, component parts of the grand piano 50A and system components of the automatic playing system 60A, muting system 80A and playback system 90A are labeled with references designating the corresponding component parts of grand piano 50 and the corresponding system components of automatic playing system 60, muting system 80 and playback system 90 without detailed description.

The recording system 70A is similar to the recording system 70 in that the information processing system 11 can receive event data codes from another musical instrument such as, for example, an electronic keyboard EK through the interface 110. While users are respectively fingering on the automatic player piano 100A and electronic keyboard EK in the MIDI plus audio recording mode, the event data codes, which express the note-on key events and note-off key events on the grand piano 50, are supplied to the sequencer 15, and the event data codes, which express the note-on key events and note-off key events on the electronic keyboard EK, are supplied through the interface 110 and information processing system 11 to the electronic tone generator 13.

The duration data codes are added to the event data codes through the sequencer 15 so as to produce the sequence music data codes, and the sequence music data codes are stored in an SMF. On the other hand, a digital external audio signal ESdw is produced through the electronic tone generator 13 on the basis of the event data codes, and the digital external audio signal ESdw is supplied through the mixer 14 to the sequencer 15 so as to produce the RIFF audio data codes Dds from the digital external audio signal. If a singer is singing a song to the accompaniment of the automatic player piano 100A and electronic keyboard EK, the digital external audio signal DSmic are mixed with the digital external audio signal ESdw, and the digital composite audio signal Sds is produced from the digital external audio signals ESdw and DSmic. The sequencer 15 converts the audio data codes of digital composite audio signal Sds to the RIFF audio data codes, and the RIFF audio data codes are stored in a RIFF file.

The mixer 14 of the automatic playing system 100A may have three rows and three columns of switches. In this instance, it is possible to supply another digital external audio signal from the electronic keyboard EK to the mixer 14, and the digital external audio signal is mixed with the digital internal audio signal Sds and digital external audio signal DSmic so as to make it possible to record the ensemble performance in the audio recording mode.

As will be understood from the foregoing description, an ensemble performance on more than one musical instrument is recorded through the single recording system 70A.

Although particular embodiments of the present invention have been shown and described, it will be apparent to those skilled in the art that various changes and modifications may be made without departing from the spirit and scope of the present invention.

The microphone 20 may be connected to the automatic player piano 100 through a radio channel instead of the cable.

A linkwork may be connected to the hammer stopper 80a. In this instance, the user manually changes the hammer stopper 80 between the free position and the blocking position. The stepping motor 80b and motor driver 8 are not required for the muting system.

The computer program may be stored in the disk driver. In this instance, the computer program is transferred from the hard disk to the random access memory 11c when the information processing system 11 is powered.

The number of signal propagation paths A to E does not set any limit to the technical scope of the present invention. In case where more than one microphone is connected to the mixer, the signal propagation paths are increased, and new switch or switches are added to the matrix. On the other hand, if the sound system 22 has another sort of signal-to-sound converter, another signal propagation path or other signal propagation paths are added to the signal propagation paths C to E together with switches.

In the recording mode, the information processing system 11 may turn the microphone 20 off by cutting the electric power to be supplied to the microphone 20 or by changing the switches 144-2, 144-4 and 144-6 to the off state. Similarly, the information processing system 11 may stop the supply of event data codes to the electronic tone generator 13 or deactivate the electronic tone generator 13. Another way to make the digital internal audio signal Sdw invalid is to turn the switches 144-1, 144-3 and 144-5 off.

In order to prohibit the loudspeakers 21 from the conversion to the electronic tones, the information processing system 11 may stop the analog composite audio signal. Otherwise, the information processing system 11 may turn the switches 144-3 and 144-4 off. The volume controller 143-3 and switches 144-3 and 144-4 may be directly controlled by the user through the touch screen 130.

Similarly, the information processing system 11 may stop the analog composite audio signal so as to prohibit the headphone 22 from the conversion to the electronic tones. Otherwise, the information processing system 11 may turn the switches 144-5 and 144-6 off. The volume controller 143-4 and switches 144-5 and 144-6 may be directly controlled by the user through the touch screen 130.

The SMF and/or RIFF file may be transferred from the memory system 16 to the disk driver 120 so as to be stored in the information storage medium.

Plural combinations of results of options may be registered in a list. The list may be stored in the memory system 16. In this instance, the information processing system 11 produces visual images of the list on the touch screen 130, and prompts the user to selects a combination from the list. The user may register a new combination to the list and delete a combination from the list.

Pedal position sensors and solenoid-operated pedal actuators may be further installed in the automatic player piano 100. In this instance, the pieces of pedal position data are further accumulated in the random access memory 11c so that the central processing unit 11a further produces music data codes expressing the pedal effect. The pedals are selectively depressed and released on the basis of the music data codes in the automatic playing and ensemble playback.

The sequence music data codes Dmid and audio data codes Dds may be stored in a single music file. For example, a music data file is capable of recording in stereo, and data blocks for the right channel and data blocks for the left channel are stored in the music data file. When the music data file is used for the recording, the sequence music data codes Dmid and audio data codes Dds are, by way of example, stored in the data blocks for the right channel and the data blocks for the left channel, respectively.

The conditions shown in FIGS. 4B, 4C and 5A to 5C do not set any limit to the technical scope of the present invention. In case where the user gives the answer “ON” to the fourth option in conditions expressed as the visual images shown in FIG. 5B, the user records both of the voice and performance on the grand piano 50 in the RIFF file. However, the user hears both of the acoustic piano tones and electronic tones through the loudspeakers 21. A countermeasure is to permit the user manually to turn the switches on and off on the touch screen 130. If the user feels the electronic tones corresponding to the acoustic piano tones noisy, the user may turns the switch 144-3 off, and renders the loudspeakers 21 radiating the electronic tones only expressing the voice.

The sequence music data codes Dmid and RIFF audio data codes Dds may be output from the sequencer 15 through the interface 110 and an USD (Universal Serial Bus) cable to a personal computer system. The digital internal audio signal Sdw and digital external audio signal DSmic or the analog external audio signal Smic may be output through the interface 110 to another sort of electric device.

A communication system may be incorporated in the interface 110. In this instance, the digital data codes are supplied through a public communication network to another musical instrument remote from the automatic player piano 100 or 100A.

When a recording system of the present invention is designed to record the performance on grand piano 50/50A and the voice on microphone 20 separately in the SMF and RIFF file, the mixer 14 is removed from the recording system.

The key position sensors 9 may be provided over the keyboard 1. The key position sensors 9 may magnetically convert the physical quantity expressing the movements of keys 1b and 1c to electric signals.

The automatic player pianos 100 and 100A do not set any limit to the technical scope of the present invention. The grand piano 50 may be replaced with an upright piano, and the muting system 80 or 80A may not be installed in the grand piano 50 or 50A.

The recording system 70/70A may be incorporated in an electronic keyboard or another sorts of keyboard musical instrument. The keyboard musical instruments do not set any limit to the technical scope of the present invention. The recording system 70/70A may be connected to other sorts of musical instrument such as, for example, an electronic wind musical instrument and electronic percussion instrument.

Visual images of a music score and/or a moving picture may be produced on the touch screen 130 during performance on the grand piano 50/50A. Moreover, a video camera may be connected to the sequencer 15. In this instance, the user who is performing music tunes is converted to visual data codes so as to make the visual data codes stored in the memory system 16 synchronously with the digital audio data codes.

The duration data codes may be replaced with time data codes expressing the lapse of time from the initiation of performance on the musical instrument. In this instance, the lapse of time may be measured with a calendar clock expressing seconds, a tenth of second or a hundredth of second.

The audio data codes of composite audio data signal Sds may be stored in a music data file prepared in accordance with the Red Book. In this instance, the sequence music data codes Dmid and audio data codes are stored in the SMF and music data file, respectively, in the MIDI plus audio recording mode.

The touch screen 130 does not set any limit to the technical scope of the present invention. Users may give their instructions to the information processing system 11 through an array of button switches.

The motor driver 8, stepping motor 80b and jobs at steps S7 and S8 may be replaced with a change-over mechanism such as a grip and linkwork connected between the grip and the hammer stopper 80a. In this instance, users manually change the hammer stopper between the free position and the blocking position.

While the audio recording mode is selected from the job list, the sequence music data codes Dmid are not produced in the above-described embodiment. However, the sequence music data codes Dmid may be produced on the condition that the digital audio composite signal Sds does not contain the data information expressed by the digital internal audio signal Sdw. This feature is desirable for players who perform a piece of music without any acoustic tones, i.e., under the condition that the hammer stopper is kept in the blocking position. Thus, the sequencer 15 is selectively activated and deactivated depending upon user's instruction in the modification.

The component parts of automatic player piano 100/100A and jobs in the subroutine programs are correlated with claim languages as follows.

The SMF and RIFF file are corresponding to “at least one music data file”, and the data port of the central processing unit 11a and signal propagation path B serve as “a first data receiving port” and “a second data receiving port”, respectively. The pieces of event data, which are stored in the event data codes Smid, are corresponding to “pieces of first audio data”, and the MIDI protocols are equivalent to “first data recording protocols”. The pieces of audio data, which are stored in the audio data codes of digital composite audio signal Sds, are corresponding to “pieces of second audio data”, and the RIFF protocols are equivalent to “second data recording protocols”. The sequence music data codes Dmid are corresponding to “first audio data codes”, and the RIFF audio data codes Dds are corresponding to “second audio data codes.”

The information processing system 11 serves as “an information processing system”, and the subroutine program for recording serves as “a computer program”.

The central processing unit 11a and jobs at steps S34 and S36 to S38 realizes “a first data producer”, and the central processing unit 11a and jobs at steps S3 and S39 to 41 realizes “a second data producer”. The central processing unit 11a and jobs at steps S43 and S44 realizes “a file producer”.

The black keys 1b and white keys 1c are corresponding to “plural manipulator”, and the central processing unit 11a, a part of the subroutine program for producing event data codes and key sensors 9 serve as “a music data producer”. The interface 110 is corresponding to “an interface”. The microphone 20 or the electronic keyboard EK serves as “an external music data source.”

The central processing unit 11a, key sensors 9 and part of the subroutine program for producing the event data codes serve as an “event data generator”, and the microphone 20 and mixer 22 form in combination a “waveform data generator”. In case where another musical instrument is connected to the interface 110, the electronic tone generator 13 serves as the “waveform data generator.” The central processing unit 11a and jobs at steps S36, S37 and S38 serve as a “clock.”

The electronic tone generator 13 is corresponding to an “electronic tone generator”, and the digital internal audio signal Sdw is representative of “pieces of third audio data.” The switches 144-1 and 144-2 serve as a “first switch” and a “second switch”, respectively. The switches 144-3 and 144-5 and switches 144-4 and 144-6 form in combination a “third switch” and a “fourth switch”, respectively.

The touch screen 130 serves as a “man-machine interface.” The action units 3, hammers 2, strings 4 and dampers 6 as a whole constitute a “tone generator.” The hammer stopper 80a is corresponding to a “stopper”, and the stepping motor 80b, motor driver 8, information processing system 11 and jobs at steps S7 and S8 serve as a “stopper controller.”

What is claimed is:

1. A recording system comprising:
an information processing system for outputting pieces of performance information;
an electronic tone generator connected to said information processing system, and producing a tone waveform signal on the basis of said pieces of performance information;
a microphone picking up external sound, and outputting a sound waveform signal;
a mixer connected to said electronic tone generator and said microphone, and outputting an output waveform signal on the basis of said tone waveform signal and said sound waveform signal, and
a sequencer connected to said information processing system and said mixer, and converting said pieces of performance information and said output waveform signal to pieces of performance sequence data and pieces of audio data, respectively,
wherein, in case where an audio recording mode is selected, said information processing system makes said sequencer not to produce said pieces of performance sequence data.
